(19) United States
(12) Patent Application Publication
(10) Pub. No.: US 2009/0059758 A1
(43) Pub. Date: Mar. 5, 2009

(54) OPTICAL INFORMATION RECORDING MEDIUM AND METHOD FOR MANUFACTURING THE SAME

(75) Inventors: Takashi Nishihara, Osaka (JP); Akio Tsuchino, Osaka (JP); Rie Kojima, Osaka (JP); Noboru Yamada, Osaka (JP)

Correspondence Address: WENDEROTH, LIND & PONACK L.L.P., 2033 K. STREET, NW, SUITE 800, WASHINGTON, DC, 20006, US

(73) Assignee: Matsushita Electric Industrial Co., Ltd., Osaka (JP)

(21) Appl. No.: 11/910,713

(22) PCT Filed: Mar. 2, 2006
(86) PCT No.: PCT/JP2006/303979

§ 371 Date: Oct. 4, 2007

(30) Foreign Application Priority Data
Apr. 7, 2005 (JP) 2005-110596

(51) Int. Cl. G11B 7/00

(52) U.S. Cl. 369/94; G9B/7

(57) ABSTRACT

To provide an optical information recording medium having an information layer of excellent transmittance and signal intensity, an optical information recording medium 22 includes at least one information layer. The information layer includes a recording layer on which information can be recorded and/or from which information can be reproduced by the irradiation of a laser beam 11, and a Ce containing layer containing Ce and O.

### BACKGROUND OF THE INVENTION

1. Technical Field

The present invention relates generally to an optical information recording medium for recording, erasing, rewriting and/or reproducing information optically and a method for manufacturing the same.

2. Background Information

One type of conventional information recording medium is a phase-change type information recording medium. Information is recorded, erased, and rewritten on the phase-change type information recording media by utilizing a phenomenon in which a recording layer (a phase change material layer) changes between a crystalline phase and an amorphous phase. Among the phase-change type information recording media, a type that utilizes a laser beam for recording, erasing, rewriting or reproducing information optically is called an optical phase-change type information recording medium. This optical phase-change type information recording medium has a recording layer made of a phase change material that changes between the crystalline phase and the amorphous phase by heat from a laser beam. A difference in reflectance between the crystalline phase and the amorphous phase is detected so as to read the information from the recording layer. Among the optical phase-change type information recording media, a rewritable optical phase-change type information recording medium is one in which recorded information can be erased or rewritten. In other words, a rewritable optical phase-change type information recording medium has a recording layer whose initial state is usually in the crystalline phase. In general, when recording information, the recording layer is melted with irradiation of a laser beam having a higher power (a recording power) than that for erasing and cooled abruptly, so that the irradiated portion is changed to an amorphous phase. On the other hand, when erasing information, the recording layer is warmed with irradiation of a laser beam having a lower power (an erasing power) than that for recording and cooled gradually, so that the irradiated portion is changed to a crystalline phase. Therefore, it is possible to record or rewrite new information on the rewritable optical phase-change type information recording medium while erasing recorded information by irradiating a recording layer with a laser beam whose power is modulated between a high power level and a lower power level. In addition, among the optical phase-change type information recording media, a write once optical phase-change type information recording medium is one in which information can be recorded only once and the recorded information cannot be erased or rewritten. The write once optical phase-change type information recording medium has a recording layer whose initial state is usually in the amorphous phase. When recording information in this type of information recording medium, the recording layer is heated with irradiation of a laser beam having a high power (a recording power) and is then cooled gradually, so that the irradiated portion is changed to the crystalline phase.

One example of an optical phase-change type information recording medium is a 4.7 GB/DVD-RAM that is disclosed in Japanese Unexamined Patent Publication No. 2001-322357. The 4.7 GB/DVD-RAM basically has a seven-layered structure, as shown in FIG. 8, in which the seven-layered structure includes a first dielectric layer 2, a first interface layer 3, a recording layer 4, a second interface layer 5, a second dielectric layer 6, a light absorption adjusting layer 7 and a reflective layer 8 on a substrate 1 in this order viewed from the laser incident side to form an information recording medium 12.

The first dielectric layer 2 and the second dielectric layer 6 have an optical function of adjusting an optical distance so as to increase light absorption efficiency of the recording layer 4, and increasing a difference in reflectance between the crystalline phase and the amorphous phase so as to increase the signal intensity. The first dielectric layer 2 and the second dielectric layer 6 also have a thermal function of thermally insulating the substrate 1, a dummy substrate 10 or the like that is heat-sensitive from the recording layer 4 whose temperature becomes high when information is recorded. (ZnS)₈₀(SiO₂)₂₀ (mol %) that has been used as a material is a superior dielectric material that is transparent and has a high refractive index, a low thermal conductivity for a good thermal insulation, good mechanical characteristics and good resistance to humidity.

As a material of the recording layer 4, a fast crystallization material containing (Ge—Sn) Te—Sb₂Te₃ is used, which is obtained by replacing Ge with Sn partially in the GeTe—Sb₂Te₃ quasi-binary line of phase change materials. The GeTe—Sb₂Te₃ quasi-binary line is a mixture of compounds GeTe and Sb₂Te₃ that realize not only good initial recording and rewriting performance but also a good record conservation property (an indicator whether or not a recorded signal can be reproduced after a long conservation) as well as a good rewriting conservation property (an indicator whether or not a recorded signal can be erased or rewritten after a long conservation).

The reflective layer 8 has an optical function of increasing quantity of light absorbed by the recording layer 4 and a thermal function of rapidly dispersing heat generated in the recording layer 4 for rapid cooling so that the recording layer 4 becomes amorphous easily. The reflective layer 8 also has a function of protecting a multi-layered film from the surrounding environment.

Utilizing the techniques described above, superior rewriting performance and high reliability have been realized in the process of commercializing the 4.7 GB/DVD-RAM.

Furthermore, in recent years, various techniques have been researched to provide larger storage capacity for information recording media. For example, in an optical phase-change type information recording medium, a technique has been researched for achieving high density recording by using a blue-violet laser having a shorter wavelength than that of a conventionally used red laser or using a thin substrate on the side on which a laser beam is incident and an objective lens having a large numerical aperture (NA) to reduce the spot diameter of the laser beam.

Furthermore, a technique has been researched to provide an optical phase-change type information recording medium having two information layers (it will be referred to as “two-layer optical phase-change type information recording medium”) to double the storage capacity and to reproduce the record of the two information layers by the laser beam which is incident from one side (Refer to Unexamined Patent Publication 2000-36130 (Page 2-11 and FIG. 2, for example) and Unexamined Patent Publication 2002-144736 (Page 2-14 and FIG. 3, for example)). In the two-layer optical phase-change type information recording medium, using a laser beam passing through an information layer of the side close to the incident side of the laser beam (it will be referred to as “first information layer”, hereinafter), in order to reproduce the record in an information layer of the side far from the incident side of the laser beam (it will be referred to as “second information layer”), it is necessary to improve the transmittance in the first information layer. Conventionally, we inventors have improved the transmittance by extremely reducing the thickness of the recording layer or reflective layer in the above described cases.

However, if the thickness of the recording layer and reflective layer are reduced in the first information layer of the two-layer optical phase-change type information recording medium, the difference in reflectance of the recording layer between the crystal phase and amorphous phase becomes smaller. Accordingly, a problem of deteriorating the signal quality of the first information layer occurs.

### SUMMARY OF THE INVENTION

In order to solve the above-described problems appeared in the conventional technologies, it is an object of the present invention to, regardless of the number of the information layers, provide an optical information recording medium having the information layer with better transmittance and signal intensity.

In order to solve the above-described problem, an optical information recording medium according to the present invention comprises at least one information layer. The information layer includes a recording layer on which information can be recorded and/or from which information can be reproduced by irradiating a laser beam, and a Ce containing layer containing Ce and O.

In addition, a method for manufacturing an optical information recording medium according to the present invention comprises steps of depositing a recording layer on which information can be recorded and/or from which information can be reproduced by irradiating a laser beam, and depositing a Ce containing layer by using a sputtering target containing Ce and O.

According to the optical information recording medium and method for manufacturing an optical information recording medium of the present invention, the signal quality, transmittance and signal intensity of the information layer in the optical information recording medium can be improved. In addition, according to a method for manufacturing an optical information recording medium of the present invention, it is easy to manufacture an optical information recording medium of the present invention.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross-section of one example of the layer configurations related to an information recording medium having one information layer of the present invention.

FIG. 2 is a cross-section of one example of the layer configurations related to an information recording medium having N information layers of the present invention.

FIG. 3 is a cross-section of one example of the layer configurations related to an information recording medium having two information layers of the present invention.

FIG. 4 is a cross-section of one example of the layer configurations related to an information recording medium having one information layer of the present invention.

FIG. 5 is a cross-section of one example of the layer configurations related to an information recording medium having N information layers of the present invention.

FIG. 6 is a cross-section of one example of the layer configurations related to an information recording medium having two information layers of the present invention.

FIG. 7 is a schematic of part of the configuration of a recording and reproducing device used for recording and reading the optical information recording medium of the present invention.

FIG. 8 is a cross-section of one example of the layer configuration related to 4.7 GB/DVD-RAM.

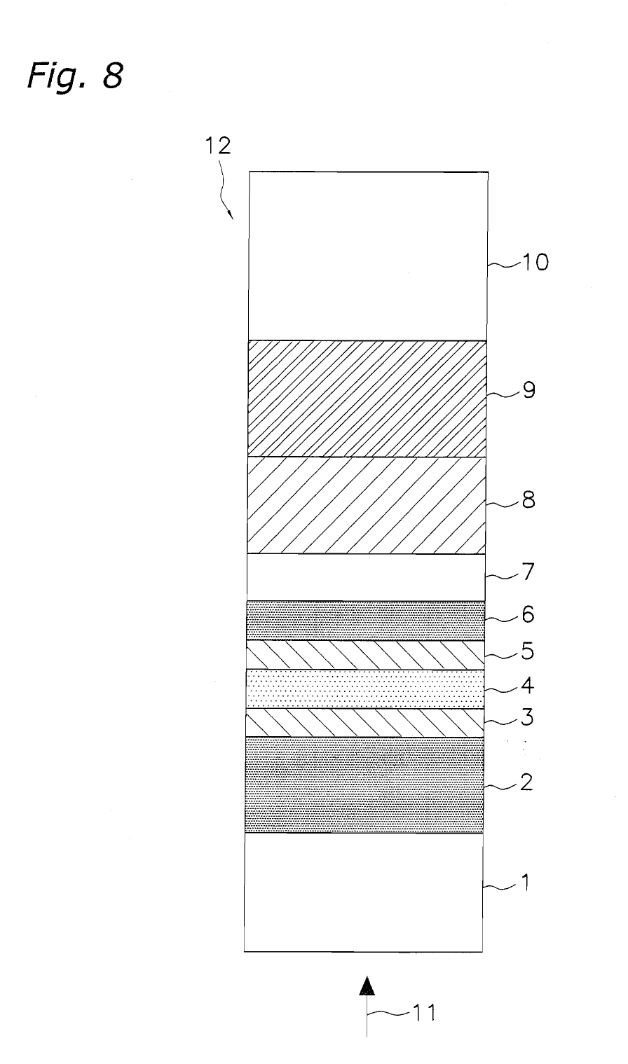

### KEY

1,14,26,30 substrate
2,102,302 first dielectric layer
3,103,303 first interface layer
4,104 recording layer
5,105,305 second interface layer
6,106,306 second dielectric layer
7 light absorption adjusting layer
8,108 reflective layer
9,27 adhesive layer
10,28 dummy substrate
11 laser beam
12,15,22,24,29,31,32,37 information recording medium
13 transparent layer
16,18,21 information layer
17,19,20 optical separation layer
23 first information layer
25 second information layer
33 spindle motor
34 objective lens
35 semiconductor laser
36 optical head
38 recording and reproduction device
   107,307 interface layer
109,209,309 Ce containing layer
202 third dielectric layer
203 third interface layer
204 first recording layer
205 fourth interface layer
206 fourth dielectric layer
208 first reflective layer
304 second recording layer
308 second reflective layer

### DETAILED DESCRIPTION OF THE PREFERRED EMBODIMENTS

Embodiments of the present invention will now be described in specific terms through reference to the drawings. The following embodiments are merely examples, and the present invention is not limited to these embodiments. Also, those components that are the same in the following embodiments are numbered the same and may not be described redundantly.

### Embodiment 1

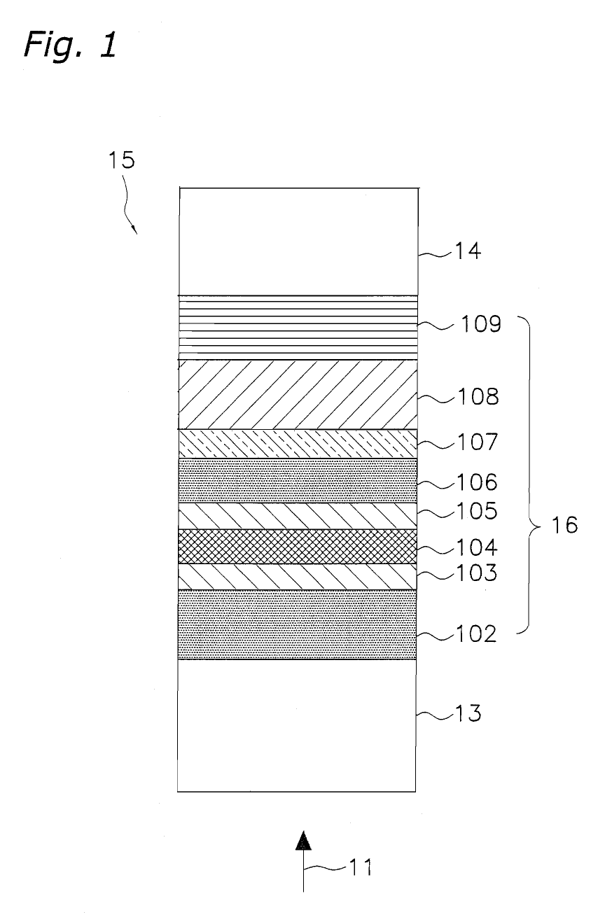

As a first embodiment, an example of an optical information recording medium according to the present invention will be explained. A partial cross sectional view of an information recording medium 15 according to the first embodiment is shown in FIG. 1. The information recording medium 15 is preferably an optical information recording medium on which information can be recorded and/or from which information can be reproduced by applying a laser beam 11.

The information recording medium 15 includes a substrate 14, an information layer 16 formed on the substrate 14, and a transparent layer 13 formed on the information layer 16.

The transparent layer 13 is made of a resin material such as a photo-curing resin (especially an ultraviolet curing resin) and a delayed action resin, or a dielectric. The resin material of the transparent layer 13 preferably has a small value of light absorption of the laser beam 11 as well as a small value of optical double refraction in the short wavelength range. In this case, the transparent layer 13 can be bonded to a first dielectric layer 102 by using a resin. The transparent layer 13 can be a transparent disk-like resin such as a polycarbonate, an amorphous polyolefin, and a PMMA, or a glass.

A wavelength λ of the laser beam 11 is preferably less than or equal to 450 nm for high density recording because the spot diameter of the collected laser beam 11 depends on the wavelength λ (the shorter the wavelength λ is, the smaller the spot diameter becomes). If the wavelength λ is shorter than 350 μm, then the light absorption by the transparent layer 13 and others become excessive. Thus, it is more preferable that the wavelength λ is within the range of 350-450 nm.

The substrate 14 is a transparent disk-like substrate. The side surface of the substrate 14 that faces the information layer 16 can be provided with a guide groove for leading the laser beam, if necessary. The other side surface of the substrate 14 that faces away from the information layer 16 is preferably smooth.

The substrate 14 can be made of a resin such as a polycarbonate, an amorphous polyolefin, and a PMMA, or a glass. As a material of the substrate 14, a polycarbonate is particularly useful for its superiority in transferring property and productivity and for its low cost.

Note that a thickness of the substrate 14 is preferably within the range of 0.5-1.2 mm so that sufficient intensity is ensured and a thickness of the information recording medium 15 becomes approximately 1.2 mm. If the thickness of the transparent layer 13 is approximately 0.6 mm, then recording and reproducing can be performed very well with the numeral aperture (NA) of the objective lens being equal to 0.6. Accordingly, it is preferable for the transparent layer 13 to be within the range of 0.55-0.65 mm when recording and reproducing at NA=0.6. If the thickness of the transparent layer 13 is approximately 0.1 mm, then recording and reproducing can be performed very well at NA=0.85. Accordingly, it is preferable for the transparent layer 13 to be within the range of 1.05-1.15 mm when recording and reproducing at NA=0.85.

Hereinafter, a structure of the information layer 16 will be described in detail.

The information layer 16 includes the first dielectric layer 102, a first interface layer 103, a recording layer 104, a second interface layer 105, a second dielectric layer 106, a reflective layer 108, and a Ce containing layer 109 that are arranged in this order from the incident side of the laser beam 11.

The first dielectric layer 102 is made of a dielectric material. The first dielectric layer 102 has a function of protecting the recording layer 104 from oxidation, pitting corrosion, deformation or the like. This first dielectric layer 102 also has a function of adjusting the optical distance so as to enhance the light absorption efficiency of the recording layer 104, and increasing a difference in reflected light quantity between before and after recording so as to increase the signal intensity. The first dielectric layer 102 can be made of an oxide such as TiO₂, ZrO₂, HfO₂, ZnO, Nb₂O₅, Ta₂O₅, SiO₂, SnO₂, Al₂O₃, Bi₂O₃, Cr₂O₃, Ga₂O₃, In₂O₃, Sc₂O₃, Y₂O₃, La₂O₃, Gd₂O₃, Dy₂O₃, Yb₂O₃, MgO, CeO₂, and TeO₂. Alternatively, the first dielectric layer 102 can be made of a nitride such as C—N, Ti—N, Zr—N, Nb—N, Ta—N, Si—N, Ge—N, Cr—N, Al—N, Ge—Si—N and Ge—Cr—N. Alternatively, the first dielectric layer 102 can be made of a sulfide such as ZnS, a carbide such as SiC, a fluoride such as LaF₃, or C. Alternatively, the first dielectric layer 102 can be made of a mixture of the above-mentioned materials. For example, ZnS—SiO₂, which is a mixture of ZnS and SiO₂, is particularly good as the material of the first dielectric layer 102. The reason is that ZnS—SiO₂ is an amorphous material and has a high refractive index, a high film formation rate, good mechanical properties, and good resistance to humidity.

The film thickness of the first dielectric layer 102 can be determined precisely by calculation in accordance with the matrix method so that quantity of reflected light changes substantially between the case where the recording layer 104 is in the crystalline phase and the case where it is in the amorphous phase.

The first interface layer 103 has a function of preventing material transfer that can be generated between the first dielectric layer 102 and the recording layer 104 by recording repeatedly.

The first interface layer 103 is preferably made of a material that has less absorption of light and a high melting point so that it is not melted when recording information. As a result, the first interface layer 103 does not melt into the recording layer 104 when the laser beam 11 with a high power is applied. If the material of the first interface layer 103 is mixed, a composition of the recording layer 104 changes and the rewriting performance is deteriorated especially. It is a preferable characteristic in which the material of the first interface layer 103 has good adhesiveness to the recording layer 104 in order to secure reliability of the information recording medium 15.

The first interface layer 103 can be made of a material that belongs to the same line as the material of the first dielectric layer 102. Among them, a material containing Cr and O is particularly preferable for promoting crystallization of the recording layer 104. Among them, a material containing an oxide in which Cr and O form Cr₂O₃ is preferable for the first interface layer 103. The material containing Cr₂O₃ has a good adhesiveness to the recording layer 104. Alternatively, the first interface layer 103 can be made of a material that contains Ga and O as well. Among them, a material containing an oxide in which Ga and O forms Ga₂O₃ is preferable. The material containing Ga₂O₃ has a good adhesiveness to the recording layer 104. Also, a material containing In and O can be used. It is preferable to contain In₂O₃ as an oxide. In₂O₃ is a material that has better adhesiveness to the recording layer 104, too. Alternatively, the first interface layer 103 can further contain at least one element selected from among Zr, Hf, and Y. The material containing ZrO₂ and HfO₂ is transparent and has a high melting point at approximately 2700-2800 degrees Celsius. It also has a low thermal conductivity among oxides and has a good repeated rewriting performance. Y₂O₃ is a transparent material and has a function of stabilizing ZrO₂ and HfO₂. Mixing these three types of oxides, even if the first interface layer 103 is formed so as to contact the recording layer 104 partially, it is possible to realize the information recording medium 15 having a superior repeated rewriting performance and high reliability. It is preferable that the first interface layer 103 containing 10 mol % or more of Cr₂O₃ or Ga₂O₃ or In₂O₃ is used so that the adhesiveness to the recording layer 104 can be secured. Furthermore, a material that contains 70 mol % or less of Cr₂O₃ can be used so that the light absorption by the first interface layer 103 is kept in a small quantity.

The first interface layer 103 can also be made of a material that contains Si. The material containing SiO₂ has a high transparency so that a first information layer 16 has a good recording performance. A content of SiO₂ in the first interface layer 103 is preferably more than or equal to 5 mol %, and less than or equal to 50 mol % so as to secure adhesiveness to the recording layer 104. More preferably, the content of SiO₂ is more than or equal to 10 mol % and less than or equal to 40 mol %.

The first interface layer 103 preferably has a film thickness within the range of 0.5-15 nm, and more preferably within the range of 1-7 nm so that the difference in quantity of the light reflected by the information layer 16 between before and after recording information is not reduced due to the light absorption in the first interface layer 103.

The second interface layer 105 has a function of preventing material transfer that can be generated between the second dielectric layer 106 and the recording layer 104 by recording repeatedly, similarly to the first interface layer 103.

The second interface layer 105 can be made of a material of the same line as the first dielectric layer 102. Among them, a material containing Ga and O is particularly preferable for the second interface layer 105. Also, a material containing an oxide in which Ga and O form Ga₂O₃ is preferable for the second interface layer 105. Alternatively, a material containing Cr and O is particularly preferable for the second interface layer 105. Also, a material containing an oxide in which Cr and O form Cr₂O₃ is preferable for the second interface layer 105. Alternatively, a material containing In and O can be used. Among them, it is preferable to contain In₂O₃ as an oxide. Other than these, as the first interface layer 103, the second interface layer 105 can contain at least one element selected from among Zr, Hf and Y, and further a material containing Si can be used. As the second interface layer 105 has a tendency to have worse adhesiveness than the first interface layer 103, it is preferable that the second interface layer 105 contains 20 mol % or more of Cr₂O₃, Ga₂O₃, or In₂O₃, which is more than the content in the first interface layer 103.

The second interface layer 105 preferably has a film thickness within the range of 0.5-75 nm and more preferably within the range of 2-40 nm. By selecting the film thickness of the second dielectric layer 106 in this range, heat generated in the recording layer 104 can be diffused effectively to the reflective layer 108 side.

The second dielectric layer 106 is disposed between the second interface layer 105 and the reflective layer 108, and can be made of a material of the same line as the first dielectric layer 102. The second dielectric layer 106 preferably has a film thickness within the range of 2-75 nm and more preferably within the range of 2-40 nm. By selecting the film thickness of the second dielectric layer 106 in this range, heat that is generated in the recording layer 104 can be diffused effectively to the reflective layer 108 side.

The first recording layer 104 is made of a material that causes the phase change between the crystalline phase and the amorphous phase when being irradiated with the laser beam 11. The first recording layer 104 can be made up of a material that causes a reversible phase change and contains Ge, Te or M2 (the element M2 is preferably at least one element of Sb, Bi and In), for example. More specifically, the first recording layer 104 can be made of a material that can be represented by a composition formula Ge_{A}M2_{B}Te_{3+A}. It is preferable that the relationship 0≦A≦60 is satisfied, and it is more preferable that the relationship 4≦A≦40 is satisfied, so that the amorphous phase is stable, the record conservation property at a low transfer rate is good, increase of the melting point is less, drop of the crystallization speed is less and rewriting conservation property at a high transfer rate is good. It is more preferable that the relationship 1.5≦B≦7 is satisfied, and it is more preferable that the relationship 2≦B≦4 is satisfied, so that the amorphous phase is stable, and the drop of the crystallization speed is less.

The recording layer 104 can be made of a material represented by a composition formula (Ge-M3)_{A}M2_{B}Te_{3+A} (the element M3 is preferably at least one element selected from Sn and Pb) that undergoes a reversible phase change. When this material is used, the element M3 that substitutes Ge improves crystallization ability so that a sufficient erasing ratio can be obtained even if the recording layer 104 is thin. The element M3 is preferably Sn because it has no toxicity. When this material is used for element M3, it is also preferable that the following relationships are satisfied: 0≦A≦60 (more preferably 4≦A≦40) and 1.5≦B≦7 (more preferably 2≦B≦4). The recording layer 104 can also be made of a material containing Sb and the element M4 for example (the element M4 is at least one of elements selected from the group consisting of V, Mn, Ga, Ge, Se, Ag, In, Sn, Te, Pb, Bi, Tb, Dy and Au) that causes the reversible phase change. More specifically, the recording layer 104 can be made of a material represented by a composition formula Sb_{X}M4_{100-X} (at %). If the value of x satisfies the relationship 50≦x≦95, then a difference in the reflectance of the information recording medium 15 can be increased between the case in which the recording layer 104 is in the crystalline phase and the case in which the recording layer 104 is in the amorphous phase, so that good recording and reproducing characteristics can be obtained. If the relationship 75≦x≦95 is satisfied, then the crystallization speed is particularly high, and good rewriting performance is obtained at a high transfer rate. If the relationship 50≦x≦75 is satisfied, then the amorphous phase is particularly stable, and good recording performance is obtained at a low transfer rate.

The recording layer 104 preferably has a film thickness within the range of 6-15 nm so that recording sensitivity of the information layer 16 is increased. Even in this range, if the recording layer 104 is thick, then thermal influence to neighboring areas increases due to diffusion of heat in the in-plane direction. If the recording layer 104 is thin, then the reflectance of the information layer 16 decreases. Therefore, it is more preferable that the film thickness of the recording layer 104 is within the range of 8-13 nm.

The recording layer 104 can also be made of a material that is represented by Te—Pd—O and that causes an irreversible phase change. In this case, it is preferable that the film thickness of the recording layer 104 is within the range of 10-40 nm.

The reflective layer 108 has an optical function of increasing quantity of light that is absorbed by the recording layer 104. The reflective layer 108 also has a thermal function of diffusing heat quickly that is generated in the recording layer 104, so that the recording layer 104 can become amorphous easily. Furthermore, the reflective layer 108 also has a function of protecting the multi-layered film from the surrounding environment.

The reflective layer 108 can be made of a material of a single metal such as Ag, Au, Cu and Al, which has a high thermal conductivity. Alternatively, it can be made of an alloy such as Al—Cr, Al—Ti, Al—Ni, Al—Cu, Au—Pd, Au—Cr, Ag—Pd, Ag—Pd—Cu, Ag—Pd—Ti, Ag—Ru—Au, Ag—Cu—Ni, Ag—Zn—Al, Ag—Nd—Au, Ag—Nd—Cu, Ag—Bi, Ag—Ga, Ag—Ga—In, Ag—In, Ag—In—Sn and Cu—Si. Particularly, an Ag alloy is suitable as a material of the reflective layer 108 for its high thermal conductivity.

It is preferable that the reflective layer 108 has a film thickness of more than or equal to 30 nm so that sufficient thermal diffusion function can be obtained. In this range, if the reflective layer 108 is thicker than 200 nm, then the thermal diffusion function becomes so large that the recording sensitivity of the information layer 16 is decreased. Therefore, it is more preferable that the film thickness of the reflective layer 108 is within the range of 30-200 nm.

The Ce containing layer 109 is disposed between the substrate 14 and the reflective layer 108, and has an effect of diffusing heat that is generated in the recording layer 104. The deposition of the Ce containing layer 109 effectively protects the reflective layer 108 from water when the reflective layer 108 includes an Ag alloy, which is easily corroded by contacting with water. The Ce containing layer 109 also has a function of improving the surface nature of the reflective layer 108.

The Ce containing layer 109 can be made of a dielectric substance containing Ce and O. In this case, it is preferable to contain CeO₂ as an oxide. Alternatively, the Ce containing layer 109 can be made of a dielectric substance containing Ce, Ti and O. In this case, CeO₂—TiO₂, which is a mixture of CeO₂ and TiO₂, can be used. The Ce containing layer 109 can be made of a dielectric substance containing M1 (the element M1 is preferably at least one element selected from Nb and Bi). In this case, a dielectric substance containing D as an oxide (D is preferably at least one compound selected from Nb₂O₅ and Bi₂O₃) can be used.

It is possible to dispose an interface layer 107 between the reflective layer 108 and the second dielectric layer 106 in the information layer 16.

In this case, the interface layer 107 can be made of a material having lower thermal conductivity than the material for the reflective layer 108 mentioned above. If an Ag alloy is used for the reflective layer 108, then Al or an Al alloy can be used for the interface layer 107. Alternatively, the interface layer 107 can be made of an element such as Cr, Ni, Si and C, or an oxide such as TiO₂, ZrO₂, HfO₂, ZnO, Nb₂O₅, Ta₂O₅, SiO₂, SnO₂, Al₂O₃, Bi₂O₃, Cr₂O₃, Ga₂O₃, and In₂O₃. Alternatively, a nitride such as C—N, Ti—N, and Zr—N, Nb—N, Ta—N, Si—N, Ge—N, Cr—N, Al—N, Ge—Si—N and Ge—Cr—N can also be used. Alternatively, a sulfide such as ZnS, a carbide such as SiC, a fluoride such as LaF₃, or C can also be used. Alternatively, a mixture of the above-mentioned materials can also be used.

The film thickness of the interface layer 107 is preferably within the range of 3-100 nm (more preferably within the range of 10-50 nm).

Concerning the information layer 16, it is preferable to satisfy the relationship R_{A}<R_{C}, where the reflectance R_{C} (%) is one when the recording layer 104 is in the crystalline phase and the reflectance R_{A} (%) is one when the recording layer 104 is in the amorphous phase. Thus, the reflectance is high in the initial state where information is not recorded, so that recording and reproducing operations can be performed stably. It is preferable that R_{C} and R_{A} satisfy the relationships 0.2≦R_{A}≦10 and 12≦R_{C}≦40, and is more preferable that R_{C} and R_{A} satisfy the relationships 0.2≦R_{A}≦5 and 12≦R_{C}≦30, so that the reflectance difference (R_{C}−R_{A}) increases and good recording and reproducing characteristics are obtained.

The information recording medium 15 can be produced by the method described below.

First, the information layer 16 is deposited on the substrate 14 (whose thickness is 1.1 mm, for example). The information layer 16 includes a single layered film or a multi-layered film. The layers can be formed by sputtering the sputtering targets to be materials for each layer one by one in a deposition device.

More specifically, first, the Ce containing layer 109 is deposited on the substrate 14. The Ce containing layer 109 can be formed by sputtering a sputtering target (for example, CeO₂) consisting of a compound that constitutes the Ce containing layer 109 in an atmosphere of Ar gas or in an atmosphere of a mixed gas of Ar gas and O₂ gas. Alternatively, the Ce containing layer 109 can also be formed by reactively sputtering a sputtering target consisting of a metal that constitutes the Ce containing layer 109 in an atmosphere of a mixed gas of Ar gas and O₂ gas.

The Ce containing layer 109 can also be formed by sputtering plural sputtering targets of CeO₂, TiO₂, and D simultaneously using plural power sources. Alternatively, the Ce containing layer 109 can also be formed by sputtering a binary sputtering target or a ternary sputtering target in which some elements of CeO₂, TiO₂, and D are combined, simultaneously using plural power sources. In these cases, the sputtering is performed reactively in an Ar gas atmosphere, and an atmosphere of a mixed gas of Ar gas and O₂ gas.

Alternatively, the Ce containing layer 109 can also be formed by sputtering plural sputtering targets of Ce, Ti, and M1 simultaneously using plural power sources. Alternatively, the Ce containing layer 109 can also be formed by sputtering a binary sputtering target or a ternary sputtering target in which some elements of Ce, Ti, and M1 are combined, simultaneously using plural power sources. In these cases, the sputtering is performed in an atmosphere of a mixed gas of Ar gas and O₂ gas.

Then, the reflective layer 108 is deposited on the substrate 14 or the Ce containing layer 109. The reflective layer 108 can be formed by sputtering a sputtering target consisting of a metal or an alloy that constitutes the reflective layer 108 in an atmosphere of Ar gas or in an atmosphere of a mixed gas of Ar gas and a reactive gas (at least one gas selected from the group consisting of O₂ gas and N₂ gas)

Then, the interface layer 107 is deposited on the reflective layer 108. The interface layer 107 can be formed by sputtering a sputtering target consisting of an element or a compound that constitutes the interface layer 107 in an atmosphere of Ar gas or in an atmosphere of a mixed gas of Ar gas and a reactive gas.

Then, the second dielectric layer 106 is deposited on the reflective layer 108 or the interface layer 107. The second dielectric layer 106 can be formed by the same method as the interface layer 107.

Then, the second interface layer 105 is deposited on the reflective layer 108, the interface layer 107 or the second dielectric layer 106. The second interface layer 105 can be formed by the same method as the interface layer 107.

Then, the recording layer 104 is deposited on the second interface layer 105. The recording layer 104 can be formed by sputtering a sputtering target consisting of a Ge—Te-M2 alloy, a sputtering target consisting of a Ge-M3-Te-M2 alloy, a sputtering target consisting of a Sb-M4 alloy, or a sputtering target consisting of a Te—Pd alloy in accordance with its composition by using one power source.

As the atmosphere gas for sputtering, a mixed gas of Ar gas, Kr gas, or a mixed gas of Ar gas and a reactive gas, or a mixed gas of Kr gas and a reactive gas can be used. The recording layer 104 can also be formed by sputtering plural sputtering targets of Ge, Te, M2, M3, Sb, M4 and Pd simultaneously using plural power sources. The recording layer 104 can also be formed by sputtering a binary sputtering target or a ternary sputtering target in which some elements of Ge, Te, M2, M3, Sb, M4 and Pd are combined, simultaneously using plural power sources. In these cases, the sputtering is performed in an Ar gas atmosphere, a Kr gas atmosphere, an atmosphere of a mixed gas of Ar gas and a reactive gas, or an atmosphere of a mixed gas of Kr gas and a reactive gas.

Then, the first interface layer 103 is deposited on the recording layer 104. The first interface layer 103 can be formed by the same method as the interface layer 107.

Then, the first dielectric layer 102 is deposited on the first interface layer 103. The first dielectric layer 102 can be formed by the same method as the interface layer 107.

Finally, the transparent layer 13 is formed on the first dielectric layer 102. A photo-curing resin (especially an ultraviolet curing resin) or a delayed action resin is applied on the first dielectric layer 102 for spin coating and then the resin is cured, thereby forming the transparent layer 13. Alternatively, a transparent disk-like substrate made of a resin such as a polycarbonate, an amorphous polyolefin, and a PMMA, or a glass can be used as the transparent layer 13. In this case, a photo-curing resin (especially an ultraviolet curing resin) or a delayed action resin is applied on the first dielectric layer 102 for pressing the substrate against the first dielectric layer 102 and spin coating them and then the resin is cured, thereby forming the transparent layer 13. Alternatively, it is possible to apply an adherent resin on the substrate uniformly in advance and bring the substrate into intimate contact with the first dielectric layer 102.

Note that an initialization process can be performed for crystallizing the entire surface of the recording layer 104 after the first dielectric layer 102 is deposited, or after the transparent layer 13 is formed, if necessary. The crystallization of the recording layer 104 can be performed by applying a laser beam.

The information recording medium 15 can be produced as described above. Although the sputtering method is used for depositing a film of each layer in this embodiment, it will be apparent from this disclosure that other methods can be used. For example, a vacuum evaporation method, an ion plating method, a CVD method, an MBE method or the like can be used.

### Embodiment 2

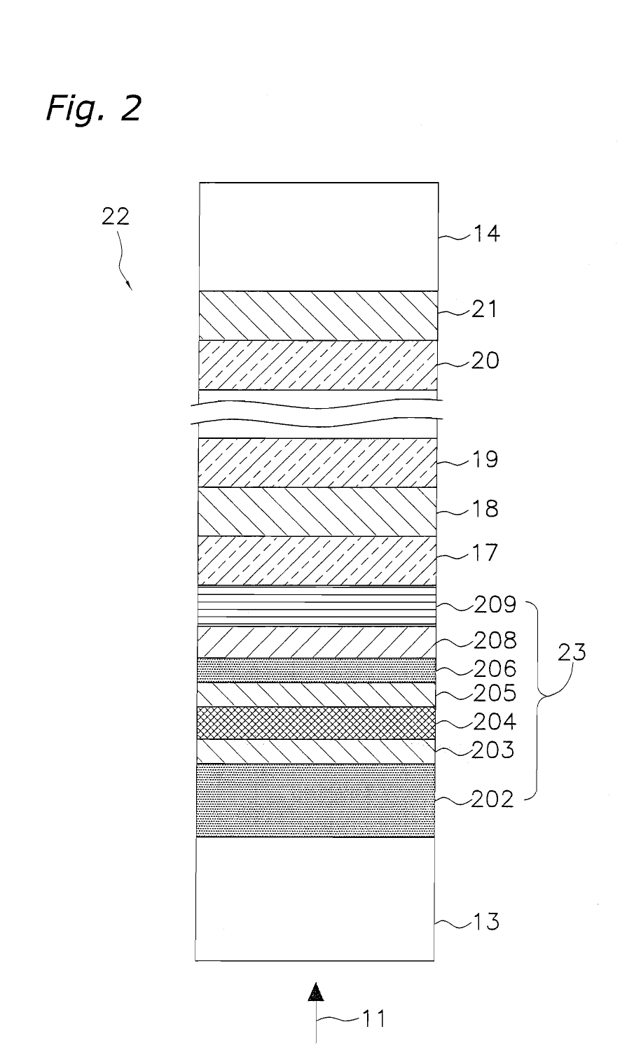

As a second embodiment, an example of an information recording medium according to the present invention will be described. A partial cross section view of an information recording medium 22 according to the second embodiment is shown in FIG. 2. The information recording medium 22 is a multi-layered optical information recording medium that can record and reproduce information by applying a laser beam 11 from one side.

The information recording medium 22 has N sets (N is a natural number that satisfies the relationship N≧2) of information layers (including the information layer 21, the information layer 18, and the first information layers 23) that are formed successively on the substrate 14 via the optical separation layers 20, 19, 17 and other optical separation layers, and the transparent layer 13. The first information layer 23 and the information layer 18 of up to (N−1) th set counted from the incident side of the laser beam 11 (an information layer of N-th set counted from the incident side of the laser beam 11 will be hereinafter referred to as “the N-th information layer”.) are light-transmitting information layers. The substrate 14 and transparent layer 13 can be made of the same material as described in the first embodiment. In addition, the shapes and the functions are also the same as those described in the first embodiment.

The optical separation layers 17, 19, 20 and other optical separation layers are made of a resin such as a photo-curing resin (especially an ultraviolet curing resin) and a delayed action resin, or a dielectric or the like. It is preferable that light absorption of the laser beam 11 by each of them is small, and that optical double refraction is small in the short wavelength range.

The optical separation layers 17, 19, 20 and other optical separation layers are provided for discriminating focal positions of the first information layer 23, the information layers 18 and 21, and the other informational layers of the information recording medium 22. The optical separation layers 17, 19, 20 and other optical separation layers are required to have a thickness more than or equal to a focal depth AZ that is determined by a numerical aperture NA of an objective lens and the wavelength λ of the laser beam 11. The value of ΔZ can be obtained by the approximate equation ΔZ=λ/{2(NA)²} supposing that a reference of intensity at a focal point is 80% of a stigmatic case. If λ is equal to 405 μm and NA is equal to 0.85, AZ is determined to be 0.280 μm. The range from −0.3 μm to +0.3 μm is within the focal depth. In this case, therefore, the optical separation layers 17, 19, 20 and other optical separation layers are required to have a thickness of 0.6 μm or more. It is desirable that a distance between the first information layer 23 and each of the other information layers 18, 21, etc. is set to be a value in a range that enables collection of the laser beam 11 using the objective lens. Therefore, it is preferable that a total sum of the thickness value of the optical separation layers 17, 19, 20 and other optical separation layers is within a tolerance that the objective lens can permit (less than or equal to 50 μm, for example).

A guide groove for leading the laser beam can be formed on the surfaces of the optical separation layers 17, 19, 20 and other optical separation layers on the incident side of the laser beam 11, if necessary.

In this case, information can be recorded and/or reproduced on the K-th information layer (K is a natural number that satisfies the relationship 1<K≦N) by the laser beam 11 that is applied from one side and passes the first information layer through (K−1) th information layer.

Note that any of the first information layer through the N-th information layer can be a read only type (ROM) information layer or a write once type (WO) information layer.

Hereinafter, a structure of the first information layer 23 will be described in detail.

The first information layer 23 includes a third dielectric layer 202, a third interface layer 203, a first recording layer 204, a fourth interface layer 205, a first reflective layer 208, and a Ce containing layer 209 that are arranged in this order from the incident side of the laser beam 11.

The third dielectric layer 202 can be made of the same material as the first dielectric layer 102 in the first embodiment. In addition, functions of them are the same as those of the first dielectric layer 102 in the first embodiment.

A film thickness of the third dielectric layer 202 can be determined precisely by calculation in accordance with the matrix method so that quantity of reflected light changes substantially between the case where the first recording layer 204 is in the crystalline phase and the case where it is in the amorphous phase, and that the first recording layer 204 absorbs light largely, and that the first information layer 23 has large transmittance.

The third interface layer 203 can be made of the same material as the first interface layer 103 in the first embodiment. In addition, functions and shapes of them are the same as those of the first interface layer 103 in the first embodiment.

The fourth interface layer 205 has a function of adjusting an optical distance so as to enhance the light absorption efficiency of the first recording layer 204 and the function of increasing a difference in the reflected light quantity between before and after recording so as to increase the signal intensity.

The fourth interface layer 205 can be made of a material in the same line as the second interface layer 105 or the second dielectric layer 106 in the first embodiment. The fourth interface layer 205 preferably has a film thickness within a range of 0.5-75 nm and more preferably within the range of 1-40 nm. By selecting the film thickness of the fourth interface layer 205 in the above range, heat generated in the first recording layer 204 can be diffused effectively to the first reflective layer 208 side.

Note that a fourth dielectric layer 206 can be disposed between the fourth interface layer 205 and the first reflective layer 208 in the first information layer 23. The fourth dielectric layer 206 can be made of a material in the same line as the second dielectric layer 106 in the first embodiment.

The first recording layer 204 is made of a material that causes the phase change between the crystalline phase and the amorphous phase when being irradiated with the laser beam 11. The first recording layer 204 can be made up of a material that causes a reversible phase change and contains Ge, Te or M2, for example. More specifically, the first recording layer 104 can be made of a material that can be represented by the composition formula Ge_{A}M2_{B}Te_{3+A}. It is preferable that the relationship 0<A≦60 is satisfied, and it is more preferable that the relationship 4≦A≦40 is satisfied, so that the amorphous phase is stable, the record conservation property at a low transfer rate is good, increase of the melting point is less, drop of the crystallization speed is less and rewriting conservation property at a high transfer rate is good. It is preferable that the relationship 1.5≦B≦7 is satisfied, and it is more preferable that the relationship 2≦B≦4 is satisfied, so that the amorphous phase is stable, and the drop of the crystallization speed is smaller.

The first recording layer 204 can be made of a material that is represented by a composition formula (Ge-M3)_{A}M2_{B}Te_{3+A} and causes a reversible phase change. When this material is used, the element M3 that substitutes Ge improves the crystallization ability so that a sufficient erasing ratio is obtained even if the first recording layer 204 is thin. As the element M3, Sn is more preferable for its no toxicity. When this material is used, it is preferable to satisfy the relationships 0≦A≦60 (more preferably 4≦A≦40) and 1.5≦B≦7 (more preferably 2≦B≦4).

In order to ensure light quantity of laser necessary for recording and reproducing that reaches the information layer at a farther side than the first information layer 23 from the incident side of the laser beam 11, transmittance of the first information layer 23 is required to be high. For this reason, it is preferable that the first recording layer 204 has a film thickness of less than or equal to 9 nm, and it is more preferable that the film thickness is within the range of 2-8 nm.

The first recording layer 204 can also be made of a material that causes an irreversible phase change and is represented by a compound Te—Pd—O. In this case, it is preferable that the first recording layer 204 has a film thickness within the range of 5-30 nm.

The first reflective layer 208 has an optical function of increasing quantity of light that is absorbed by the first recording layer 204. The first reflective layer 208 also has a thermal function of diffusing quickly heat that is generated in the first recording layer 204 so that the first recording layer 204 becomes amorphous easily. Furthermore, the first reflective layer 208 also has a function of protecting the multi-layered films from the surrounding environment.

The first reflective layer 208 can be made of the same material as the reflective layer 108 in the first embodiment. In addition, functions of them are the same as those of the reflective layer 108 in the first embodiment. Particularly, an Ag alloy is preferable as a material of the first reflective layer 208 because it has a large thermal conductivity.

The first reflective layer 208 preferably has a film thickness within the range of 3-15 nm and is more preferable to be within the range of 8-12 nm so that transmittance of the first information layer 23 becomes as high as possible. When the film thickness of the first reflective layer 208 is within this range, the thermal diffusion function and the reflectance of the first information layer 23 is sufficiently secured. Furthermore, sufficient transmittance of the first information layer 23 can be secured.

The Ce containing layer 209 is made of a dielectric and has a function of adjusting the transmittance of the first information layer 23. The Ce containing layer 209 makes it possible to raise both the transmittance T_{C} (%) of the first information layer 23 (one when the first recording layer 204 is in the crystalline phase) and the transmittance T_{A} (%) of the first information layer 23 (one when the first recording layer 204 is in the amorphous phase). More specifically, the transmittance of the first information layer 23 with the Ce containing layer 209 is higher than that without the Ce containing layer 209 by approximately 2-10%. The Ce containing layer 209 also has an effect of diffusing heat that is generated in the first recording layer 204. Accordingly, it will be understood that the Ce containing layer 209 is effective if it is disposed near the first information layer 23, which is on the side on which the laser beam 11 is incident.

A refractive index nₜ and an extinction coefficient kₜ of the Ce containing layer 209 are preferable to satisfy the relationships 2.0≦nₜ and kₜ≦0.1, and are more preferable to satisfy the relationships 2.4≦nₜ≦3.0 and kₜ≦0.05, so as to enhance the action of increasing the transmittances T_{C} and T_{A} of the first information layer 23.

It is preferable that a film thickness L of the Ce containing layer 209 satisfies the relationship ( 1/32)λ/nₜ≦L≦( 3/16)λ/nₜ or ( 17/32)λ/nₜ≦L≦( 11/16)λ/nₜ, and it is more preferable to satisfy the relationship ( 1/16)λ/nₜ≦L≦( 5/32)λnₜ or ( 9/16)λnₜ≦L≦( 21/32)λnₜ. Note that the above relationships are preferable to be 3 nm≦L≦40 nm or 60 nm≦L≦130 nm and are more preferable to be 7 nm≦L≦30 nm or 65 nm≦L≦120 nm by selecting the wavelength λ of the laser beam 11 and the refractive index nₜ of the Ce containing layer 209 to satisfy the relationships 350 nm≦λ≦450 nm and 2.0≦nₜ≦3.0, for example. By selecting a value of L within this range, both the transmittances T_{C} and T_{A} of the first information layer 23 can be set to high values.

The Ce containing layer 209 can be made of the same materials as those of the Ce containing layer 109 in the embodiment 1. These materials have a large refractive index (n=2.6-2.8) and a small extinction coefficient (k=0.0-0.05), so the action of increasing transmittance of the first information layer 23 is enhanced.

Transmittances T_{C} and T_{A} of the first information layer 23 are preferable to satisfy 40<T_{C} and 40<T_{A} and are more preferable to satisfy 46<T_{C} and 46<T_{A}, so that sufficient quantity of laser necessary for recording and reproducing can reach the information layer that is farther than the first information layer 23 from the incident side of the laser beam 11.

Transmittances T_{C} and T_{A} of the first information layer 23 are preferable to satisfy −5≦(T_{C}−T_{A})≦5 and are preferable to satisfy −3≦(T_{C}−T_{A})≦3. When the values of T_{C} and T_{A} satisfy these conditions, influence of change of the transmittance depending on a state of the first recording layer 204 of the first information layer 23 becomes small upon recording and reproducing on the information layer that is farther than the first information layer 23 from the incident side of the laser beam 11, so that the better recording and reproducing characteristics can be obtained.

In the first information layer 23, it is preferable that reflectance R_{C1}(%) (one when the first recording layer 204 is in the crystalline phase) and reflectance R_{A1}(%) (one when the first recording layer 204 is in the amorphous phase) satisfy the relationship R_{A1}<R_{C1}. Thus, the reflectance become high in the initial state where no information is recorded, so that recording and reproducing operation can be performed stably. It is preferable that values of R_{C1} and R_{A1} satisfy 0.1≦R_{A1}≦5 and 4≦R_{C1}≦15, and it is more preferable that they satisfy 0.1≦R_{A1}≦3 and 4≦R_{C1}≦10 so that a reflectance difference (R_{C1}−R_{A1}) becomes large, thereby obtaining good recording and reproducing characteristics.

A description will be made hereinafter on a method for manufacturing information recording medium 22.

First, (N−1) information layers are formed or laminated on the substrate 14 (having a thickness of 1.1 mm, for example) one by one with one of the optical separation layers separating adjacent pair of the information layers. The information layer consists of a single layered film or a multi-layered film, and the layers can be formed by sputtering the sputtering targets to be the materials for each layer one by one in the deposition device.

The optical separation layers can be formed by applying a photo-curing resin (especially an ultraviolet curing resin) or a delayed action resin on the information layer, rotating the substrate 14 so as to extend the resin uniformly (spin coat), and curing the resin. Note that if the optical separation layer has a guide groove for the laser beam 11, the guide groove can be formed by bringing a substrate (a die) with the groove into intimate contact with the resin before being cured, rotating the substrate 14 and the top die for spin-coating, curing the resin, and then removing the substrate (the die).

In this way, the (N−1) information layers are formed on the substrate 14 together with the optical separation layers separating adjacent pair of the information layers. Then, the optical separation layer 17 is further formed on these information layers.

Next, the first information layer 23 is formed on the optical separation layer 17. More specifically, the substrate 14, on which the (N−1) information layers are formed together with the optical separation layers and the optical separation layer 17 is formed, is placed in the deposition device, and then the Ce containing layer 209 is deposited on the optical separation layer 17. The Ce containing layer 209 can be formed by the same method as the Ce containing layer 109 in the first embodiment.

Then, the first reflective layer 208 is deposited on the Ce containing layer 209. The first reflective layer 208 can be formed by the same method as that of the reflective layer 108 in the first embodiment.

Then, the fourth dielectric layer 206 is deposited on the first reflective layer 208. The fourth dielectric layer 206 can be formed by the same method as that of the interface layer 107 in the first embodiment.

Then, the fourth interface layer 205 is deposited on the first reflective layer 208 or the fourth dielectric layer 206. The fourth interface layer 205 can be formed by the same method as that of the interface layer 107 in the first embodiment.

Then, the first recording layer 204 is deposited on the fourth interface layer 205. The first recording layer 204 can be formed by using a sputtering target corresponding to the composition thereof and by the same method as that of the recording layer 104 in the first embodiment.

Then, the third interface layer 203 is deposited on the first recording layer 204. The third interface layer 203 can be formed by the same method as the interface layer 107 in the first embodiment.

Then, the third dielectric layer 202 is deposited on the third interface layer 203. The third dielectric layer 202 can be formed by the same method as the interface layer 107 in the first embodiment.

Finally, the transparent layer 13 is formed on the third dielectric layer 202. The transparent layer 13 can be formed by the method that is described in the first embodiment.

Note that the initialization process can be performed for crystallizing the entire surface of the first recording layer 204 after forming the third dielectric layer 202 or after forming the transparent layer 13, if necessary. The crystallization of the first recording layer 204 can be performed by applying the laser beam.

In this way, the information recording medium 22 can be manufactured. Note that although the sputtering method is used for forming films of layers in this embodiment, the present invention is not limited to the sputtering method. For example, a vacuum evaporation method, an ion plating method, a CVD method, an MBE method or other methods can be used.

### Embodiment 3

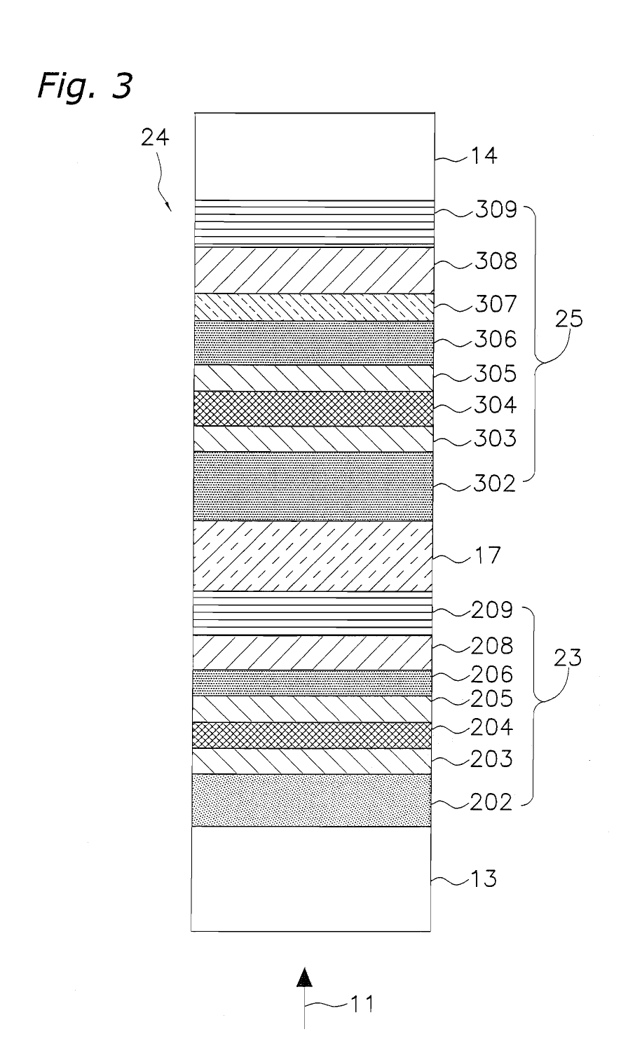

As a third embodiment, an example of the information recording medium will be described, which includes two sets (N=2) of information layers in the multi-layered optical information recording medium in the second embodiment of the present invention. A partial cross sectional view of an information recording medium 24 according to the third embodiment is shown in FIG. 3.

The information recording medium 24 is a two-layered optical information recording medium that can record and reproduce information by applying a laser beam 11 from a single side.

The information recording medium 24 includes the second information layer 25, the optical separation layer 17, the first information layer 23 and the transparent layer 13 over the substrate 14 in this order. The substrate 14, the optical separation layer 17, the first information layer 23, and the transparent layer 13 can be made of the same material as described in the first and the second embodiments. In addition, the shapes and the functions are also the same as those described in the first and the second embodiments.

Hereinafter, a structure of a second information layer 25 will be described in detail.

The second information layer 25 includes a first dielectric layer 302, a first interface layer 303, a second recording layer 304, a second interface layer 305, and a second reflective layer 308 that are arranged in this order from the incident side of the laser beam 11. The second information layer 25 records and reproduces information by the laser beam 11 that passes the transparent layer 13, the first information layer 23 and the optical separation layer 17.

The first dielectric layer 302 can be made of the same material as that of the first dielectric layer 102 in the first embodiment. In addition, the functions of the first dielectric layer 302 are also the same as those of the first dielectric layer 102 in the first embodiment.

A film thickness of the first dielectric layer 302 can be determined precisely by calculation in accordance with a matrix method so that quantity of reflected light changes substantially between the case where the second recording layer 304 is in the crystalline phase and the case where it is in the amorphous phase.

The first interface layer 303 can be made of the same material as that of the first interface layer 103 in the first embodiment. In addition, the functions and shapes of the first interface layer 303 are also the same as those of the first interface layer 103 in the first embodiment.

The second interface layer 305 can be made of the same material as that of the second interface layer 105 in the first embodiment. In addition, the functions and shapes of the second interface layer 305 are also the same as those of the second interface layer 105 in the first embodiment.

It is possible to dispose the second dielectric layer 306 between the second interface layer 305 and the second reflective layer 308 in the second information layer 25. The second dielectric layer 306 can be made of the same material as the second dielectric layer 106 in the first embodiment. In addition, the functions and the shapes of the second dielectric layer 306 are also the same as those of the second dielectric layer 106 in the first embodiment.

The second recording layer 304 can be made of the same material as that of the recording layer 104 in the first embodiment.

The second recording layer 304 preferably has a film thickness within the range of 6-15 nm so as to increase the recording sensitivity of the second information layer 25 if the material thereof is a material that causes a reversible phase change (for example, Ge_{A}M2_{B}Te_{3+A}). In this range, if the second recording layer 304 is thick, then thermal influence to neighboring areas increases due to diffusion of heat in the in-plane direction. If the second recording layer 304 is thin, then the reflectance of the second information layer 25 decreases. Therefore, it is more preferable that the film thickness of the second recording layer 304 is within the range of 8-13 nm.

If a material that causes an irreversible phase change (for example, Te—Pd—O) is used for the second recording layer 304, it is preferable that the second recording layer 304 has a film thickness within the range of 10-40 nm, similarly to the first embodiment.

The second reflective layer 308 can be made of the same material as that of the reflective layer 108 in the first embodiment. In addition, the functions and the shapes of the second reflective layer 308 are also the same as those of the reflective layer 108 in the first embodiment.

Alternatively, the Ce containing layer 309 can be disposed between the substrate 14 and the second reflective layer 308 in the second information layer 25. The Ce containing layer 309 can be made of the same material as the Ce containing layer 109 in the first embodiment. In addition, the functions and shapes of the Ce containing layer 309 are also the same as those of the Ce containing layer 109 in the first embodiment.

It is possible to dispose an interface layer 307 between the second reflective layer 308 and the second dielectric layer 306 in the second information layer 25. The interface layer 307 can be made of the same material as that of the interface layer 107 in the first embodiment. In addition, the functions and the shapes of the interface layer 307 are also the same as those of the interface layer 107 in the first embodiment.

The information recording medium 24 can be manufactured by the method described below.

First, the second information layer 25 is formed.

More specifically, the substrate 14 (having a thickness of 1.1 mm, for example) is prepared first and is placed in the deposition device.

Then, the Ce containing layer 309 is deposited on the substrate 14. On this occasion, if a guide groove for leading the laser beam 11 is formed on the substrate 14, the Ce containing layer 309 is deposited on the side where the guide groove is formed. The Ce containing layer 309 can be formed by the same method as that of the Ce containing layer 109 in the first embodiment.

Then, the second reflective layer 308 is deposited on the substrate 14 or the Ce containing layer 309. The second reflective layer 308 can be formed by the same method as that of the reflective layer 108 in the first embodiment.

Then, the interface layer 307 is deposited on the second reflective layer 308. The interface layer 307 can be formed by the same method as that of the interface layer 107 in the first embodiment.

Then, the second dielectric layer 306 is deposited on the second reflective layer 308 or the interface layer 307. The second dielectric layer 306 can be formed by the same method as that of the interface layer 107 in the first embodiment.

Then, the second interface layer 305 is deposited on the second reflective layer 308, the interface layer 307 or the second dielectric layer 306. The second interface layer 305 can be formed by the same method as the interface layer 107 in the first embodiment.

Then, the second recording layer 304 is deposited on the second interface layer 305. The second recording layer 304 can be formed by using a sputtering target corresponding to the composition thereof and by the same method as that of the recording layer 104 in the first embodiment.

Then, the first interface layer 303 is deposited on the second recording layer 304. The first interface layer 303 can be formed by the same method as that of the interface layer 107 in the first embodiment.

Then, the first dielectric layer 302 is deposited on the first interface layer 303. The first dielectric layer 302 can be formed by the same method as that of the interface layer 107 in the first embodiment.

Then, the optical separation layer 17 is formed on the first dielectric layer 302 of the second information layer 25. The optical separation layer 17 can be formed by applying a photo-curing resin (especially an ultraviolet curing resin) or a delayed action resin onto the first dielectric layer 302 for spin coating and by curing the resin. Note that if the optical separation layer 17 has a guide groove for the laser beam 11, a substrate (a die) on which the groove is formed is brought into intimate contact with the resin before being cured, and then the resin is cured. After that, the substrate (the die) is removed so that the guide groove can be formed. Note that an initialization process can be performed for crystallizing the entire surface of the second recording layer 304 after depositing the first dielectric layer 302 or after forming the optical separation layer 17, if necessary. The crystallization of the second recording layer 304 can be performed by applying the laser beam.

Next, the first information layer 23 is formed on the optical separation layer 17.

More specifically, the Ce containing layer 209, the first reflective layer 208, the fourth interface layer 205, the first recording layer 204, the third interface layer 203 and the third dielectric layer 202 are deposited in this order on the optical separation layer 17 first. On this occasion, the fourth dielectric layer 206 can be formed between the first reflective layer 208 and the fourth interface layer 205, if necessary. These layers can be formed by the method described in the second embodiment.

Finally, the transparent layer 13 is formed on the third dielectric layer 202. The transparent layer 13 can be formed by the method described in the first embodiment.

Note that an initialization process can be performed for crystallizing the entire surface of the first recording layer 204 after depositing the third dielectric layer 202 or after forming the transparent layer 13, if necessary. The crystallization of the first recording layer 204 can be performed by applying the laser beam.

An initialization process can be performed for crystallizing the entire surface of the second recording layer 304 and the first recording layer 204 after forming the third dielectric layer 202 or after forming the transparent layer 13, if necessary. In this case, there is a tendency for a laser power necessary for crystallizing the second recording layer 304 to increase if the crystallization of the first recording layer 204 is performed first. Therefore, it is preferable that crystallization of the second recording layer 304 is performed first.

In this way, the information recording medium 24 can be manufactured. Note that although the sputtering method is used for forming films of layers in this embodiment, the present invention is not limited to the sputtering method. For example, a vacuum evaporation method, an ion plating method, a CVD method, an MBE method or other methods can be used.

### Embodiment 4

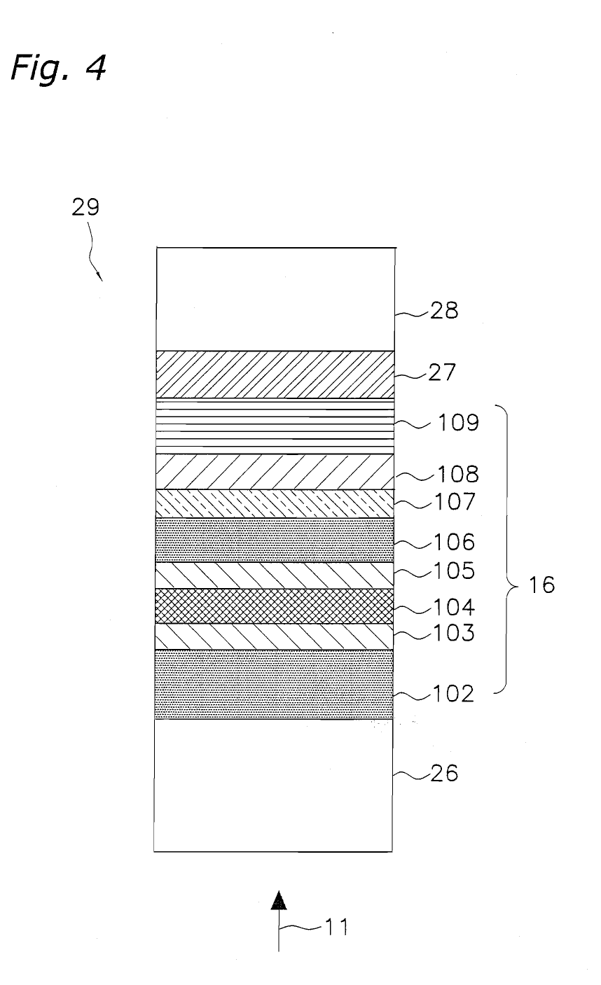

As a fourth embodiment, another example of an information recording medium according to the present invention will be described. A partial cross section view of an information recording medium 29 according to the fourth embodiment is shown in FIG. 4. The information recording medium 29 is an optical information recording medium that can record and reproduce information by applying a laser beam 11 in the same way as the information recording medium 15 in the first embodiment.

The information recording medium 29 has a structure in which the information layer 16 is formed on the substrate 26 and a dummy substrate 28 is glued onto the information layer 16 via an adhesive layer 27.

The substrate 26 and the dummy substrate 28 are transparent and have a disk-like shape. The substrate 26 and the dummy substrate 28 can be made, for example, of a resin such as a polycarbonate, an amorphous polyolefin, and a PMMA, or a glass, in the same manner as the substrate 14 in the first embodiment.

The surface of the substrate 26 on one side that faces the first dielectric layer 102 can be provided with a guide groove for leading the laser beam, if necessary. It is preferable that the surface of the substrate 26 on the side opposite to the first dielectric layer 102 and the surface of the dummy substrate 28 on the side opposite to the adhesive layer 27 are smooth. As a material of the substrate 26 and the dummy substrate 28, a polycarbonate is particularly useful for its superior transferring property and productivity as well as a low cost. Note that thickness values of the substrate 26 and the dummy substrate 28 are preferable to be within the range of 0.3-0.9 mm so that sufficient intensity is secured and a thickness of the information recording medium 29 can be approximately 1.2 mm.

It is preferable that the adhesive layer 27 is made of a resin such as a photo-curing resin (especially an ultraviolet curing resin) and a delayed action resin, and it has less light absorption of the laser beam 11 that is used. It is also preferable that the adhesive layer 27 has a small optical double refraction in the short wavelength range. Note that it is preferable that a thickness of the adhesive layer 27 is within the range of 0.6-50 μm for the same reason as the optical separation layers 19, 17 and the other optical separation layers.

Descriptions about other portions that are denoted by the same reference numerals as the first embodiment are omitted.

A description will be hereinafter made on a method for manufacturing the information recording medium 29.

First, the information layer 16 is formed on the substrate 26 (having a thickness of 0.6 mm, for example). On this occasion, if a guide groove for leading the laser beam 11 is formed on the substrate 26, the information layer 16 is formed on the side where the guide groove is formed. More specifically, the substrate 26 is placed in the deposition device, and then the first dielectric layer 102, the first interface layer 103, the recording layer 104, the second interface layer 105, and the reflective layer 108 are deposited sequentially. The second dielectric layer 106 can be deposited between the second interface layer 105 and the reflective layer 108. Note that the interface layer 107 can be deposited between the second dielectric layer 106 and the reflective layer 108, if necessary. The Ce containing layer 109 can be deposited on the reflective layer 108. The method for depositing the layers is the same as that of the first embodiment.

Next, the substrate 26 on which the information layer 16 is formed and the dummy substrate 28 (having a thickness of 0.6 mm, for example) are glued to each other via the adhesive layer 27. More specifically, a resin such as a photo-curing resin (especially an ultraviolet curing resin) and a delayed action resin is applied on the dummy substrate 28. The substrate 26 on which the information layer 16 is formed is brought into intimate contact with the dummy substrate 28 for spin coating, and then the resin is cured. Alternatively, it is possible to apply an adherent resin on the dummy substrate 28 uniformly in advance and bring it into intimate contact with the substrate 26 on which the information layer 16 is formed.

Note that an initialization process can be performed for crystallizing the entire surface of the recording layer 104 after bringing the substrate 26 into intimate contact with the dummy substrate 28, if necessary. The crystallization of the recording layer 104 can be performed by applying the laser beam.

In this way, the information recording medium 29 can be manufactured. Note that although the sputtering method is used for forming films of layers in this embodiment, the present invention is not limited to the sputtering method. For example, a vacuum evaporation method, an ion plating method, a CVD method, an MBE method or other methods can be used.

### Embodiment 5

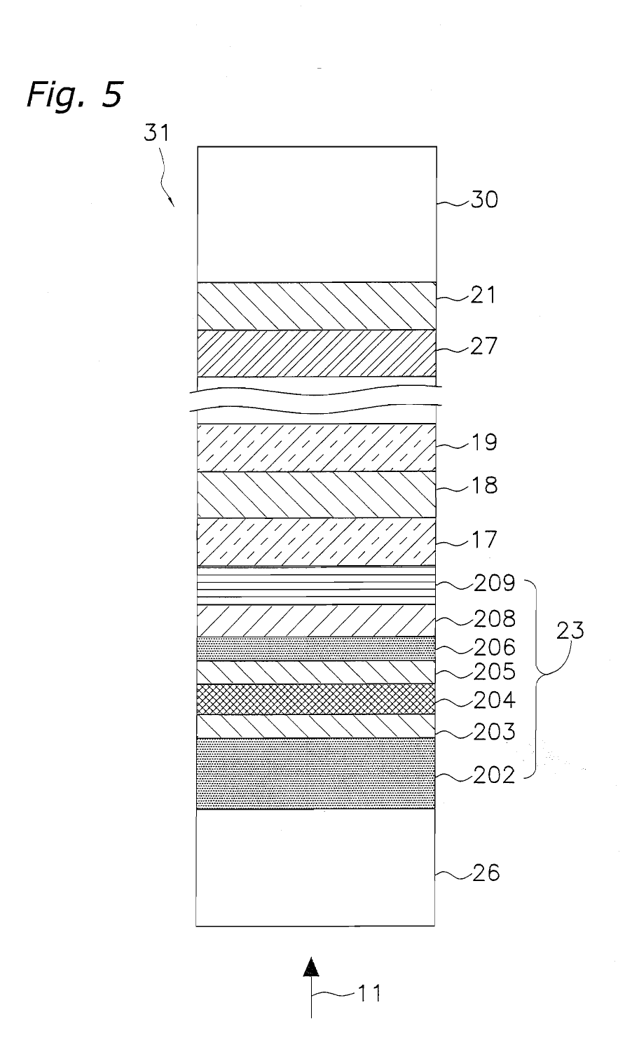

As a fifth embodiment, an example of an information recording medium according to the present invention will be described. A partial cross section view of an information recording medium 31 according to the fifth embodiment is shown in FIG. 5. The information recording medium 31 is a multi-layered optical information recording medium that can record and reproduce information by applying a laser beam 11 from one side similarly to the information recording medium 22 in the second embodiment.

The information recording medium 31 has N sets of the information layers (including the first information layer 23 and the information layer 18 that are formed successively on the substrate 26 via the optical separation layers 17, 19 and other optical separation layers), and the information layer 21 formed on a substrate 30 that are brought into intimate contact with the N sets of the information layers via the adhesive layer 27.

The substrate 30 is transparent and has a disk-like shape. The substrate 30 can be made of a resin such as a polycarbonate, an amorphous polyolefin, and a PMMA, or a glass, for example, in the same manner as the substrate 14.

The surface of the substrate 30 near the information layer 21 can be provided with a guide groove for leading the laser beam, if necessary. It is preferable that the surface of the substrate 30 on the side opposite to the information layer 21 is smooth. As a material of the substrate 30, a polycarbonate is particularly useful for its superior transferring property and productivity as well as a low cost. Note that it is preferable that a thickness of the substrate 30 is within the range of 0.3-0.9 mm so that sufficient intensity is secured and a thickness of the information recording medium 31 can be approximately 1.2 mm.

Furthermore, descriptions about other portions that are denoted by the same reference numerals as the second and fourth embodiments are omitted.

The information recording medium 31 can be manufactured by the method described below.

First, the first information layer 23 is formed on the substrate 26 (having a thickness of 0.6 mm, for example). On this occasion, if a guide groove for leading the laser beam 11 is formed on the substrate 26, the first information layer 23 is formed on the side where the guide groove is formed. More specifically, the substrate 26 is placed in the deposition device, and then the third dielectric layer 202, the third interface layer 203, the first recording layer 204, the fourth interface layer 205, the first reflective layer 208, and the Ce containing layer 209 are deposited successively. Note that the fourth dielectric layer 206 can be disposed between the fourth interface layer 205 and the first reflective layer 208. The method for depositing the layers is the same as that of the second embodiment. After that, the (N−2) information layers are sequentially deposited via the optical separation layers therebetween.

The information layer 21 is formed on the substrate 30 (having a thickness of 0.6 mm, for example). The information layer consists of a single layered film or a multi-layered film, and the layers can be formed by sputtering the sputtering targets to be the materials one by one in the deposition device in the same manner as that of the second embodiment.

Finally, the substrate 26 on which the information layer is formed and the substrate 30 are glued to each other via the adhesive layer 27. More specifically, a resin such as a photo-curing resin (especially an ultraviolet curing resin) and a delayed action resin is applied on the information layer 21. The substrate 26 on which the first information layer 23 is deposited is brought into intimate contact with the information layer 21 for spin coating, and then the resin is cured. Alternatively, it is possible to apply an adherent resin on the information layer 21 uniformly in advance and bring it into intimate contact with the substrate 26.

Note that an initialization process can be performed for crystallizing the entire surface of the first recording layer 204 after bringing the substrate 26 into intimate contact with the substrate 30, if necessary. The crystallization of the first recording layer 204 can be performed by applying the laser beam.

In this way, the information recording medium 31 can be manufactured. Note that although the sputtering method is used for forming films of layers in this embodiment, the present invention is not limited to the sputtering method. For example, a vacuum evaporation method, an ion plating method, a CVD method, an MBE method or other methods can be used.

### Embodiment 6

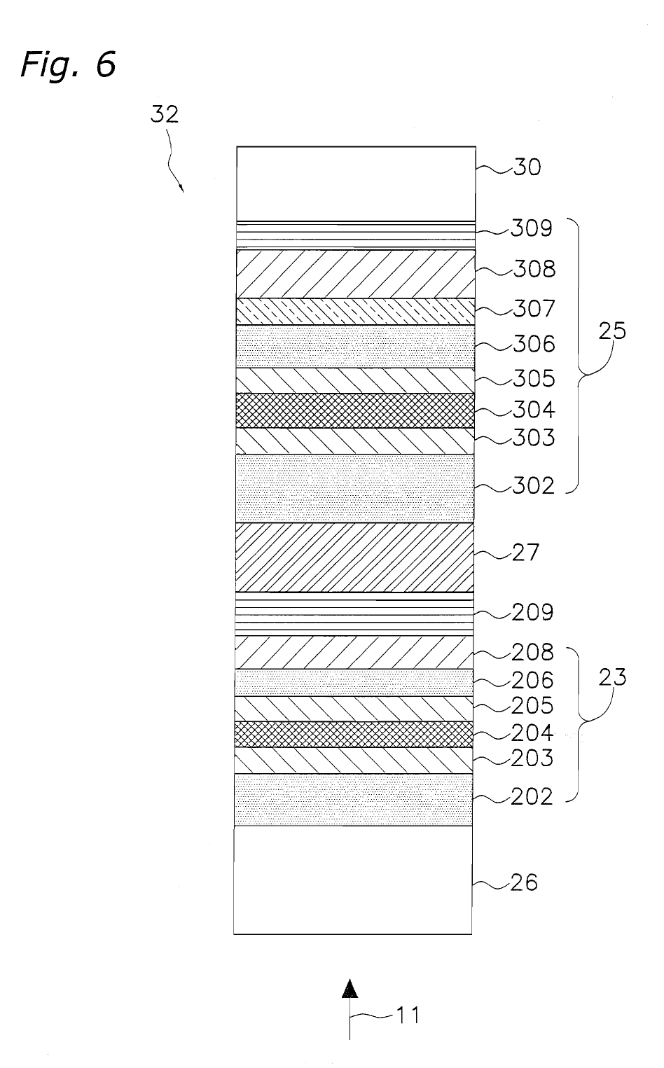

As a sixth embodiment, an example of an information recording medium will be described, which includes two sets (N=2) of information layers in the multi-layered optical information recording medium in the fifth embodiment of the present invention. A partial cross sectional view of an information recording medium 32 according to sixth embodiment is shown in FIG. 6. The information recording medium 32 is a two-layered optical medium information recording medium that can record and reproduce information by applying a laser beam 11 from a single side, similarly to the information recording medium 24 in the third embodiment.

The information recording medium 32 has a structure in which the first information layer 23 is formed on the substrate 26, the second information layer 25 is formed on the substrate 30, and they are brought into intimate contact with each other via the adhesive layer 27.

A guide groove for leading the laser beam can be formed on the surface of the substrate 30 on the side close to the second reflective layer 308, if necessary. It is preferable that the surface of the substrate 30 on the side opposite to the second reflective layer 308 is smooth.

Furthermore, descriptions about other portions that are denoted by the same reference numerals as the third, the fourth and the fifth embodiments are omitted.

The method for manufacturing the information recording medium 32 will be described.

First, the first information layer 23 is formed on the substrate 26 (having a thickness of 0.6 mm, for example) by the same method as that of the fifth embodiment.

Note that an initialization process can be performed for crystallizing the entire surface of the first recording layer 204 after forming the Ce containing layer 209, if necessary. The crystallization of the first recording layer 204 can be performed by applying the laser beam.

Then, the second information layer 25 is formed on the substrate 30 (having a thickness of 0.6 mm, for example). On this occasion, if a guide groove for leading the laser beam 11 is formed on the substrate 30, the second information layer 25 is formed on the side where the guide groove is formed. More specifically, the substrate 30 is placed in the deposition device, and then the second reflective layer 308, the second interface layer 305, the second recording layer 304, the first interface layer 303, and the first dielectric layer 302 are deposited successively. The second dielectric layer 306 can be deposited between the second reflective layer 308 and the second interface layer 305, if necessary. Note that the interface layer 307 can be deposited between the second reflective layer 308 and the second dielectric layer 306, if necessary. The Ce containing layer 309 can be formed between the substrate 30 and the second reflective layer 308. The method for forming the layers is the same as those of the third embodiment.

Note that an initialization process can be performed for crystallizing the entire surface of the second recording layer 304 after forming the first dielectric layer 302, if necessary. The crystallization of the second recording layer 304 can be performed by applying the laser beam.

Finally, the substrate 26 on which the first information layer 23 is formed and the substrate 30 on which the second information layer 25 is formed are glued to each other via the adhesive layer 27. More specifically, a resin such as a photo-curing resin (especially an ultraviolet curing resin) or a delayed action resin is applied on the first information layer 23 or the second information layer 25. The substrate 26 is brought into intimate contact with the substrate 30 for spin coating, and then the resin is cured. Alternatively, it is possible to apply an adherent resin on the first information layer 23 or the second information layer 25 uniformly in advance and bring the substrate 26 and the substrate 30 into intimate contact with each other.

After that, an initialization process can be performed for crystallizing the entire surface of the second recording layer 304 and the first recording layer 204, if necessary. In this case, it is preferable that the second recording layer 304 is crystallized first for the same reason as that of the third embodiment.

In this way, the information recording medium 32 can be manufactured. Note that although the sputtering method is used for forming films of layers in this embodiment, the present invention is not limited to the sputtering method. For example, a vacuum evaporation method, an ion plating method, a CVD method, an MBE method or other methods can be used.

### Embodiment 7

As a seventh embodiment, a method for recording and reproducing information on the information recording medium described in the first through sixth embodiments of the present invention will be described.

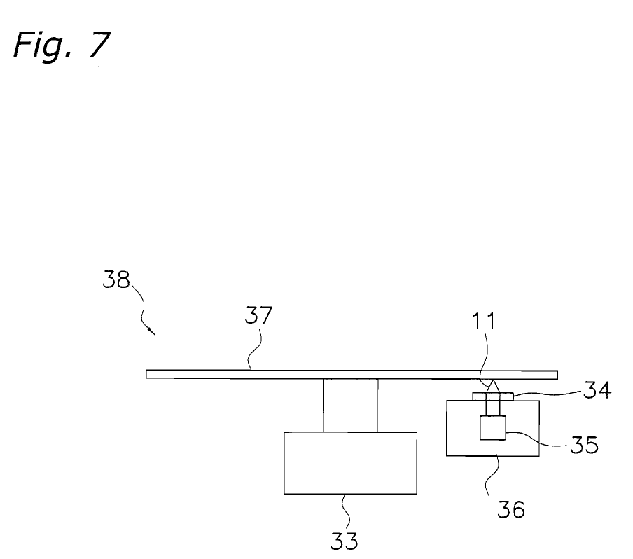

A part of the structure of a recording and reproducing device 38 is shown schematically in FIG. 7 that is used for the method of recording and reproducing information according to the present invention. The recording and reproducing device 38 includes a spindle motor 33 for rotating an information recording medium 37, an optical head 36 having a semiconductor laser 35 and an objective lens 34 for collecting the laser beam 11 emitted from the semiconductor laser 35. The information recording medium 37, which is described in the first through the sixth embodiments, includes a single (the information layer 16, for example), or a plurality of information layers (the first information layer 23 and the second information layer 25, for example). The objective lens 34 collects the laser beam 11 on the information layer.

Recording, erasing and rewriting information on the information recording medium are performed by modulating a power of the laser beam 11 between a peak power (Pwp (mW)), which is a high power, and a bias power (Pwb (mW)), which is a low power. When the laser beam 11 of the peak power is applied, the amorphous phase is formed at a portion of the recording layer, and the amorphous phase becomes a record mark. The laser beam 11 of the bias power is applied to a portion between the record marks so as to form the crystalline phase (an erased portion). Note that when the laser beam 11 of the peak power is applied, a pulse train is usually used, which is called a multipulse. Note that the multipulse can be modulated only between two values, i.e., between the peak power and the bias power, or can be modulated within the range from the zero mW to the peak power between three or four values wherein a cooling power (Pwc (mW)) and/or a bottom power PwB (mW)) lower than the bias power are added.

A reproducing power (Pwr (mW)), which has lower power level than the peak power or the bias power, does not affect an optical state of the record mark when the laser beam 11 is applied at the power level, and makes it possible to obtain sufficient reflected light quantity necessary for reproducing a record mark from the information recording medium. Then, the laser beam 11 of the reproducing power is applied so as to obtain a signal from the information recording medium, and the signal is read by a detector so that the information signal can be reproduced.

It is preferable that a numerical aperture NA of the objective lens 34 is within the range of 0.5-1.1 (more preferably within the range of 0.6-0.9) so that a spot diameter of the laser beam is adjusted to a value within the range of 0.4-0.7 μm. It is preferable that a wavelength of the laser beam 11 is less than or equal to 450 nm (more preferably within the range of 350-450 nm). It is preferable that a line speed of the information recording medium when information is recorded is within the range of 1-20 m/second (more preferably within the range of 2-15 m/second) so that reproducing light hardly causes crystallization and sufficient erasing performance can be obtained.

When information is recorded on the first information layer 23 of the information recording medium 24 or the information recording medium 32 having two information layers, the laser beam 11 is focused on the first recording layer 204, so that laser beam 11 that passes through the transparent layer 13 is used for recording information on the first recording layer 204. Reproduction of the information in the first recording layer 204 is performed by using the laser beam 11 that is reflected by the first recording layer 204 and passes through the transparent layer 13. When information is recorded on the second information layer 25, the laser beam 11 is focused on the second recording layer 304, the laser beam 11 that passes through the transparent layer 13, the first information layer 23 and the optical separation layer 17 is used for recording information in the second information layer 25. Reproduction of the second information layer 25 is performed by using the laser beam 11 that is reflected by the second recording layer 304 and passes the optical separation layer 17, the first information layer 23 and the transparent layer 13.

Note that if a guide groove for leading the laser beam 11 is formed on the substrate 14 and the optical separation layers 20, 19 and 17, information can be recorded on grooves that are close to the incident side of the laser beam 11 or on lands that are far from the same. Alternatively, it is possible to record information on both the grooves and lands.

The recording performance was evaluated by modulating the power of the laser beam 11 within the range of 0-Pwp (mW), recording random signals having mark lengths of 0.149 μm (2T) to 0.596 μm (8T) by (1-7) modulation method, and measuring jitters of leading edges and trailing edges of the record marks (errors of mark positions) by a time interval analyzer. Note that the smaller a value of the jitter is, the better the recording performance is. Note that the values of Pwp and Pwb are determined such that an average value of jitters of leading edges and trailing edges (an average jitter) becomes the minimum. An optimal Pwp on this occasion is determined as recording sensitivity.

The signal intensity was evaluated by modulating the power of the laser beam 11 within the range of 0-Pwp (mW), recording signals having mark lengths of 0.149 μm (2T) and 0.671 μm (9T) in the same groove ten times alternately and successively, and finally overwriting a 2T signal and measuring a ratio (CNR: Carrier to Noise Ratio) of a signal amplitude (a carrier level) to a noise amplitude (a noise level) at a frequency of the 2T signal by a spectrum analyzer. Note that the larger the CNR is, the larger the signal intensity is.

### EXAMPLES

Hereinafter, the present invention is further described in detail with reference to examples.

### Example 1

In example 1, the first information layer 23 of the information recording medium 24 in FIG. 3 was manufactured, and the relationship between a material and refractive index nₜ of the Ce containing layer 209 and transmittance and signal intensity of the first information layer 23 was researched. More specifically, samples of the first information layer 23 which had different materials for the Ce containing layer 209 were manufactured, and the transmittance and signal intensity of the first information layer 23 were measured.

The samples were manufactured as follows. First, as the substrate 14, a polycarbonate substrate (having a diameter of 120 mm and a thickness of 1.1 mm) was prepared that was formed with a guide groove (having a depth of 20 nm and a track pitch of 0.32 μm) to guide the laser beam 11. Then, on the polycarbonate substrate, a Ce containing layer (having a thickness of (405/8n) nm), an Ag—Pd—Cu layer (10 nm in thickness) as the reflective layer 208, (ZrO₂)₅₀(In₂O₃)₅₀ layer (having a thickness of 15 nm) as the fourth interface layer 205, Ge₂₂In_{0.5}Bi_{1.5}Te₂₅ layer (having a thickness of 6 nm) as the first recording layer 204, (ZrO₂)₅₀(Cr₂O₃)₅₀ layer (having a thickness of 5 nm) as the third interface layer 203, (ZnS)₈₀(SiO₂)₂₀ layer (having a thickness of 40 nm) as the third dielectric layer 202 were built up in that order on the polycarbonate substrate by sputtering.

Finally, the UV-curing resin was coated on the third dielectric layer 202, and the ultraviolet rays were irradiated to cure the resin, thereby forming the transparent layer 13 having a thickness of 75 μm.

As described above, a plurality of samples were manufactured that had the Ce containing layers 209 made of different materials.

Each of the samples obtained in this manner was first measured for transmittance T_{A} (%) when the first recording layer 204 was in an amorphous phase. After that, the initialization process was performed for the obtained samples so that the first recording layer 204 was crystallized, and the transmittance T_{C} (%) when the first recording layer 204 was in the crystalline phase was measured. A spectroscope was used to measure the transmittance, and the transmittance in a wavelength of 405 nm.

Furthermore, the recording and reproducing device 38 in FIG. 7 was used to measure the signal intensity of the first information layer 23 in the information recording medium 24. In this measurement, the wavelength of the laser beam 11 was 405 nm, the numerical aperture NA of the objective lens 34 was 0.85, the linear velocity of the samples when measured was 4.9 m/second, and the shortest mark length (2T) was 0.149 μm. The information was recorded on the grooves.

The evaluation result of the materials and refractive index nₜ of the Ce containing layer 209 of the first information layer 23 in the information recording medium 24, and transmittance T_{A}, T_{C} and signal intensity were shown in table 1. Note that, for the transmittance, less than 40% was evaluated as “bad”, more than or equal to 40% and less than 46% was evaluated as “unsatisfactory”, and more than or equal to 46% was evaluated as “good”. For the signal intensity, less than 40 dB was evaluated as “bad”, more than or equal to 40 dB and less than 45 dB was evaluated as “unsatisfactory” and more than or equal to 45 dB was evaluated as “good”.

TABLE 1

| Sample | material of Ce containing layer | refractive | | | signal |
|---|---|---|---|---|---|
| No. | 209 | index nₜ | T_{c} | Tₐ | intensity |
| 1-1 | CeO₂ | 2.6 | good | good | good |
| 1-2 | (CeO₂)₉₅(TiO₂)₅ | 2.6 | good | good | good |
| 1-3 | (CeO₂)₅(TiO₂)₉₅ | 2.7 | good | good | good |
| 1-4 | (CeO₂)₁(TiO₂)₉₉ | 2.7 | good | good | good |
| 1-5 | (CeO₂)₉₅(Nb₂O₅)₅ | 2.6 | good | good | good |
| 1-6 | (CeO₂)₅(Nb₂O₅)₉₅ | 2.6 | good | good | good |
| 1-7 | (CeO₂)₁(Nb₂O₅)₉₉ | 2.6 | good | good | good |
| 1-8 | (CeO₂)₉₅(Bi₂O₃)₅ | 2.6 | good | good | good |
| 1-9 | (CeO₂)₅(Bi₂O₃)₉₅ | 2.8 | good | good | good |
| 1-10 | (CeO₂)₁(Bi₂O₃)₉₉ | 2.8 | good | good | good |
| 1-11 | (CeO₂)₉₀(TiO₂)₅(Nb₂O₅)₅ | 2.6 | good | good | good |
| 1-12 | (CeO₂)₅₀(TiO₂)₂₅(Nb₂O5)₂₅ | 2.6 | good | good | good |
| 1-13 | (CeO₂)₁₀(TiO₂)₄₅(Nb₂O₅)₄₅ | 2.6 | good | good | good |
| 1-14 | (CeO₂)₉₀(TiO₂)₅(Bi₂O₃)₅ | 2.6 | good | good | good |
| 1-15 | (CeO₂)₅₀(TiO₂)₂₅(Bi₂O₃)₂₅ | 2.7 | good | good | good |
| 1-16 | (CeO₂)₁₀(TiO₂)₄₅(Bi₂O₃)₄₅ | 2.7 | good | good | good |
| 1-17 | (CeO₂)₈₅(TiO₂)₅(Nb₂O₅)₅(Bi₂O₃)₅ | 2.6 | good | good | good |
| 1-18 | (CeO₂)₄₀(TiO₂)₂₀(Nb₂O₅)₂₀(Bi2O₃)₂₀ | 2.7 | good | good | good |
| 1-19 | (CeO₂)₁₀(TiO₂)₃₀(Nb₂O5)₃₀(Bi2O₃)₃₀ | 2.7 | good | good | good |
| 1-20 | SiO₂ | 1.5 | bad | bad | bad |
| 1-21 | Al₂O₃ | 1.7 | bad | bad | unsatisfactory |
| 1-22 | ZrO₂ | 2.2 | bad | unsatisfactory | unsatisfactory |

As a result, it was found that, for sample (1-1)-(1-19), which contained Ce and O in the Ce containing layer 209, the refractive index nₜ of the Ce containing layer 209 was high, and further the transmittance of the first information layer 23 was high, and the signal intensity was good. For the samples (1-20), (1-21), and (1-22), which did not contain Ce in the Ce containing layer 209 so that the refractive index nₜ was low, the transmittance of the first information layer 23 was low, and the signal intensity was not sufficient. As a result of this, it was found that the Ce containing layer 209 preferably contains Ce and O.

### Example 2

In the example 2, the information recording medium 24 in FIG. 3 was manufactured, and a relationship between materials of the Ce containing layer 209 and the recording sensitivity and jitter of the first information layer 23 and second information layer 25. More specifically, samples of the information recording medium 24 that includes the first information layer 23 having the Ce containing layer 209 made of different materials were manufactured, and the recording sensitivity and jitter of the first information layer 23 and second information layer 25 were measured.

The samples were manufactured as follows. First, as the substrate 14, a polycarbonate substrate (having a diameter of 120 mm and a thickness of 1.1 mm) was prepared that was formed with a guide groove (having a depth of 20 nm and a track pitch of 0.32 μm) to guide the laser beam 11. Then, onto the polycarbonate substrate, Ag—Pd—Cu layer (having a thickness of 80 nm) as the second reflective layer 308, (ZrO₂)₅₀(In₂O₃)₅₀ layer (having a thickness of 22 nm) as the second interface layer 305, Ge₂₂In_{0.5}Bi_{1.5}Te₂₅ layer (having a thickness of 11 nm) as the second recording layer 304, (ZrO₂)₅₀(In₂O₃)₅₀ layer (having a thickness of 5 nm) as the first interface layer 303, (ZnS)₈₀(SiO₂)₂₀ layer (having a thickness of 60 nm) as the first dielectric layer 302 were built up in that order on the polycarbonate substrate 1 by sputtering.

Next, the UV-curing resin was coated onto the first dielectric layer 302, and a substrate formed with a guide groove (having a depth of 20 nm and a track pitch of 0.32 μm) was brought into intimate contact with the resin and was rotated to form a uniform resin layer, and the substrate was removed after the UV-curing resin was cured. By this steps, the optical separation layer 17 having a thickness of 25 μm was manufactured that was formed with the guide groove for guiding the laser beam 11 near the first information layer 23.

After that, onto the optical separation layer 17, the Ce containing layer 209 (having a thickness of (405/8n) nm), Ag—Pd—Cu layer (having a thickness of 10 nm) as the first reflective layer 208, (ZrO₂)₅₀(In₂O₃)₅₀ layer (having a thickness of 15 nm) as the fourth interface layer 205, Ge₂₂In_{0.5}Bi_{1.5}Te₂₅ layer (having a thickness of 6 nm) as the first recording layer 204, (ZrO₂)₅₀(Cr₂O₃)₅₀ layer (having a thickness of 5 nm) as the third interface layer 203, and (ZnS)₈₀(SiO₂)₂₀ layer (having a thickness of 40 nm) as the third dielectric layer 202 were built up in this order by sputtering.

Finally, the UV-curing resin was coated onto the third dielectric layer 202, and the ultraviolet ray was irradiated to cure the UV-curing resin, the transparent layer 13 having a thickness of 75 μm was formed. After that, an initialization process was performed to crystallize the second recording layer 304 and the first recording layer 204 by the laser beam.

In this way, a plurality of samples were manufactured that had the Ce containing layer 209 made of different materials.

For each of the samples obtained in this manner, the recording sensitivity and jitter of the first information layer 23 and the second information layer 25 in the information recording medium 24 were measured by the recording and reproducing device 38 in FIG. 7. At this time, wavelength of the laser beam 11 was 405 nm, the numerical aperture NA of the objective lens 34 was 0.85, the linear velocity of the sample when measured was 4.9 m/second, and the shortest mark length (2T) was 0.149 μm. The information was recorded on the grooves.

The evaluation results of the materials of the Ce containing layer 209 of the first information layer 23 in the information recording medium 24 and the recording sensitivity and jitter of the first information layer 23 and second information layer 25 were shown in table 2. Note that, for the recording sensitivity, less than 12 mW was evaluated as “good”, more than or equal to 12 mW and less than 14 mW was evaluated as “unsatisfactory”, and more than or equal to 14 mW was evaluated as “bad”. For jitter of the first information layer 23, less than 8.5% was evaluated as “good”, more than or equal to 8.5% and less than 9.5% was evaluated as “unsatisfactory” and more than or equal to 9.5% was evaluated as “bad”. For the second information layer 25, less than 6.5% was “good”, more than or equal to 6.5% and less than 7.5% was evaluated “unsatisfactory”, and more than or equal to 7.5% was evaluated as “bad”.

TABLE 2

| | | first information layer 23 | | second information layer 25 | |
|---|---|---|---|---|---|
| Sample | material of Ce containing layer | recording | | recording | |
| No. | 209 | sensitivity | jitter | sensitivity | jitter |
| 2-1 | CeO₂ | good | good | good | good |
| 2-2 | (CeO₂)₉₅(TiO₂)₅ | good | good | good | good |
| 2-3 | (CeO₂)₅(TiO₂)₉₅ | good | good | good | good |
| 2-4 | (CeO₂)₁(TiO₂)₉₉ | good | good | good | good |
| 2-5 | (CeO₂)₉₅(Nb₂O₅)₅ | good | good | good | good |
| 2-6 | (CeO₂)₅(Nb₂O₅)₉₅ | good | good | good | good |
| 2-7 | (CeO₂)₁(Nb₂O₅)₉₉ | good | good | good | good |
| 2-8 | (CeO₂)₉₅(Bi₂O₃)₅ | good | good | good | good |
| 2-9 | (CeO₂)₅(Bi₂O₃)₉₅ | good | good | good | good |
| 2-10 | (CeO₂)₁(Bi₂O₃)₉₉ | good | good | good | good |
| 2-11 | (CeO₂)₉₀(TiO₂)₅(Nb₂O₅)₅ | good | good | good | good |
| 2-12 | (CeO₂)₅₀(TiO₂)₂₅(Nb₂O₅)₂₅ | good | good | good | good |
| 2-13 | (CeO₂)₁₀(TiO₂)₄₅(Nb₂O₅)₄₅ | good | good | good | good |
| 2-14 | (CeO₂)₉₀(TiO₂)₅(Bi₂O₃)₅ | good | good | good | good |
| 2-15 | (CeO₂)₅₀(TiO₂)₂₅(Bi₂O₃)₂₅ | good | good | good | good |
| 2-16 | (CeO₂)₁₀(TiO₂)₄₅(Bi₂O₃)₄₅ | good | good | good | good |
| 2-17 | (CeO₂)₈₅(TiO₂)₅(Nb₂O₅)₅(Bi₂O₃)₅ | good | good | good | good |
| 2-18 | (CeO₂)₄₀(TiO₂)₂₀(Nb₂O₅)₂₀(Bi₂O₃)₂₀ | good | good | good | good |
| 2-19 | (CeO₂)₁₀(TiO₂)₃₀(Nb₂O₅)₃₀(Bi₂O₃)₃₀ | good | good | good | good |
| 2-20 | SiO₂ | good | bad | bad | bad |
| 2-21 | Al₂O₃ | good | unsatisfactory | bad | bad |
| 2-22 | ZrO₂ | good | unsatisfactory | unsatisfactory | bad |

As a result, it was found that for the samples (2-1)-(2-19), which had the Ce containing layer 209 containing Ce and O, the recording sensitivity and jitter of the first information layer 23 and second information layer 25 were good. For the samples (2-20), (2-21), and (2-22), which had the Ce containing layer 209 not containing Ce, the recording sensitivity and jitter of the second information layer 25 were not sufficient. From the above-described results, it was found that the Ce containing layer 209 preferably contains Ce and O.

### Example 3

In example 3, the first information layer 23 of the information recording medium 32 in FIG. 6 was manufactured to perform an experiment similar to example 1.

The samples are manufactured as follows. First, as the substrate 26, a polycarbonate substrate (having a diameter of 120 mm and a thickness of 0.6 mm) was prepared that was formed with a guide groove (having a depth of 40 nm and a track pitch of 0.344 μm) to guide the laser beam 11. Then, onto the polycarbonate substrate, (ZnS)₈₀(SiO₂)₂₀ layer (having a thickness of 40 nm) as the third dielectric layer 202, (ZrO₂)₅₀(Cr₂O₃)₅₀ layer (having a thickness of 5 nm) as the third interface layer 203, Ge₂₂In_{0.5}Bi_{1.5}Te₂₅ layer (having a thickness of 6 nm) as the first recording layer 204, the fourth interface layer 205 (having a thickness of 15 nm), Ag—Pd—Cu layer (having a thickness of 10 nm) as the first reflective layer 208, and the Ce containing layer 209 (having a thickness of (405/8n) nm) were built up in this order by sputtering.

After that, the UV-curing resin was coated onto the substrate 30 to laminate it on the Ce containing layer 209 of the substrate 26, and by rotating it, a uniform resin layer (having a thickness of 20 μm) was formed. After that, by irradiating the ultraviolet ray to cure the UV-curing resin, the substrate 26 and the substrate 30 were adhered to each other via the adhesive layer 27. Finally, an initialization process was performed to crystallize the entire area of the first recording layer 204 by the laser beam.

For the samples obtained as described, in the same way as example 1, transmittance and signal intensity of the first information layer 23 in the information recording medium 32 were measured. On this case, the wavelength of the laser beam 11 was 405 nm, the numerical aperture NA of the objective lens 34 was 0.65, the linear velocity of the samples when measured was 8.6 m/s, and the shortest mark length was 0.294 μm. The information was recorded on the grooves.

As a result, it was found that, similarly to example 1, if the Ce containing layer 209 contained Ce and O, the refractive index nₜ of the Ce containing layer 209 was high, the transmittance of the first information layer 23 was high, and the signal intensity was better. It was found that if the Ce containing layer 209 did not contain Ce and the refractive index nₜ was low, the transmittance of the first information layer 23 was low and the signal intensity was not sufficient. From the above-described facts, it was found that the Ce containing layer 209 preferably contains Ce and O.

### Example 4

In example 4, the information recording medium 32 in FIG. 6 was manufactured to perform an experiment as in example 2.

The samples were manufactured as follows. First, as the substrate 26, a polycarbonate substrate (having a diameter of 120 mm and a thickness of 0.6 mm) was prepared that was formed with a guide groove (having a depth of 40 nm and a track pitch of 0.344 μm) to guide the laser beam 11. Then, onto the polycarbonate substrate, (ZnS)₈₀(SiO₂)₂₀ layer (having a thickness of 40 nm) as the third dielectric layer 202, (ZrO₂)₅₀(Cr₂O₃)₅₀ layer (having a thickness of 5 nm) as the third interface layer 203, Ge₂₂In_{0.5}Bi_{1.5}Te₂₅ layer (having a thickness of 6 nm) as the first recording layer 204, (ZrO₂)₅₀(In₂O₃)₅₀ layer (having a thickness of 15 nm) as the fourth interface layer 205, Ag—Pd—Cu layer (having a thickness of 10 nm) as the first reflective layer 208, the Ce containing layer 209 (having a thickness of (405/8n) nm) were built up in that order by sputtering.

As the substrate 30, a polycarbonate substrate (having a diameter of 120 mm and a thickness of 0.58 mm) was prepared that was formed with a guide groove (having a depth of 40 nm and a track pitch of 0.344 μm) to guide the laser beam 11. Then, onto the polycarbonate substrate, Ag—Pd—Cu layer (having a thickness of 80 nm) as the second reflective layer 208, the second interface layer 305 (having a thickness of 22 nm), Ge₂₂In_{0.5}Bi_{1.5}Te₂₅ layer (having a thickness of 11 nm) as the second recording layer 304, (ZrO₂)₅₀(Cr₂O₃)₅₀ layer (having a thickness of 5 nm) as the first interface layer 303, and (ZnS)₈₀(SiO₂)₂₀ layer (having a thickness of 60 nm) as the first dielectric layer 302 were built up in that order by sputtering.

After that, the UV-curing resin was coated onto the first dielectric layer 302 of the substrate 30, and the substrate 30 is laminated on the Ce containing layer 209 of the substrate 26, and the substrates were rotated to form a uniform resin layer (having a thickness of 20 μm). After that, the ultraviolet ray was irradiated to cure the UV-curing resin, the substrate 26 and the substrate 30 were adhered to each other via the adhesive layer 27. Finally, an initialization process was performed to crystallize the entire surfaces of the second recording layer 304 and the first recording layer 204 by the laser beam.

For each of the samples obtained in this manner, in the same way as in example 2, the recording sensitivity and jitter of the first information layer 23 and second information layer 25 in the information recording medium 32 were measured. On this occasion, the wavelength of the laser beam 11 was 405 nm, the numerical aperture NA of the objective lens 34 was 0.65, the linear velocity of the samples when measured was 8.6 m/second, and the shortest mark length was 0.294 μm. The information was recorded on the grooves.

As a result, it was found that, similarly to example 2, if the Ce containing layer 209 contained Ce and O, the recording sensitivity and jitter of the first information layer 23 and second information layer 25 were good. It was found that the recording sensitivity and jitter of the second information layer 25 were not sufficient if the Ce containing layer 209 did not contain Ce. As a result, it was found that the Ce containing layer 209 preferably contains Ce and O.

### Example 5

In examples 1-4, as materials of the first interface layer 103, the second interface layer 105, the third interface layer 203, and the fourth interface layer 205, the material containing at least one element selected from among Zr, Hf, Y and Si; at least one element selected from among Ga, In and Cr; and O was used. The similar result was obtained. In this case, it was also found that at least one oxide selected from among ZrO₂, HfO₂, Y₂O₃ and SiO₂, and at least one oxide selected from among Ga₂O₃, In₂O₃ and Cr₂O₃ are preferably included.

### Example 6

In the examples 1-5, for the first recording layer 204 or the second recording layer 304, materials were used that were expressed by any of (Ge—Sn)Te, GeTe—Sb₂Te₃, (Ge—Sn)Te—Sb₂Te₃, GeTe—Bi₂Te₃, (Ge—Sn)Te—Bi₂Te₃, GeTe—(Sb—Bi)₂Te₃, (Ge—Sn)Te—(Sb—Bi)₂Te₃, GeTe—(Bi—In)₂Te₃ and (Ge—Sn)Te—(Bi—In)₂Te₃. The similar results were obtained.

In summary, according to the present invention, regardless of the number of the information layers, it is possible to provide an optical information recording medium having improved transmittance and signal intensity in the information layer.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

### INDUSTRIAL APPLICABILITY

Since the optical information recording medium according to the present invention can improve the transmittance and signal intensity in the information layer, the medium has characteristics of conserving the recorded information for a long time (nonvolatility), and is applicable to optical disks or the like of the rewritable and write-once type having high density.

1-19. (canceled)

20. An optical information recording medium comprising at least one information layer, the information layer including a recording layer on which information can be recorded and/or from which information can be reproduced by a laser beam irradiation, a Ce containing layer containing Ce and O, and a reflective layer between the recording layer and the Ce containing layer so as to be in contact with the Ce containing layer.

21. An optical information recording medium according to claim 20, wherein the number of the information layers is at least two, and
the information layer that includes the recording layer on which information can be recorded and/or from which information can be reproduced by the laser beam irradiation and the Ce containing layer containing Ce and O is disposed on a side on which the laser beam is incident.

22. An optical information recording medium according to claim 20, wherein the Ce containing layer contains CeO₂.

23. An optical information recording medium according to claim 20, wherein the Ce containing layer further contains at least one element selected from among Ti, Nb and Bi.

24. An optical information recording medium according to claim 23, wherein the Ce containing layer is composed of CeO₂—TiO₂.

25. An optical information recording medium according to claim 23, wherein the Ce containing layer contains at least one compound selected from Nb₂O₅ and Bi₂O₃.

26. An optical information recording medium according to claim 20, wherein the reflective layer mainly contains Ag.

27. An optical information recording medium according to claim 20, wherein the information layer further includes an interface layer between the recording layer and the reflective layer.

28. An optical information recording medium according to claim 27, wherein the interface layer contains at least one element selected from among Zr, Hf, Y and Si; at least one element selected from among Ga, In and Cr; and O.

29. An optical information recording medium according to claim 28, wherein the interface layer contains at least one oxide selected from among ZrO₂, HfO₂, Y₂O₃ and SiO₂, and at least one oxide selected from among Ga₂O₃, In₂O₃ and Cr₂O₃.

30. An optical information recording medium according to claim 20, wherein the recording layer is a phase-change type layer.

31. An optical information recording medium according to claim 30, wherein the recording layer contains at least one element selected from among Sb, Bi, In and Sn; Ge; and Te.

32. An optical information recording medium according to claim 31, the recording layer is expressed by any of (Ge—Sn)Te, GeTe—Sb₂Te₃, (Ge—Sn)Te—Sb₂Te₃, GeTe—Bi₂Te₃, (Ge—Sn)Te—Bi₂Te₃, GeTe—(Sb—Bi)₂Te₃, (Ge—Sn)Te—(Sb—Bi)₂Te₃, GeTe—(Bi—In)₂Te₃, and (Ge—Sn)Te—(Bi—In)₂Te₃.

33. A method for manufacturing an optical information recording medium comprising:
depositing a recording layer on which information can be recorded and/or from which information can be reproduced by a laser beam irradiation; and
depositing a Ce containing layer containing Ce and O by using a sputtering target including Ce and O.

34. A method for manufacturing an optical information recording medium according to claim 33, wherein the sputtering target contains at least one oxide selected from among CeO₂, TiO₂, Nb₂O₅, and Bi₂O₃; and CeO₂.

35. A method for manufacturing an optical information recording medium according to claim 33, further comprising,
depositing a reflective layer between the step of depositing the recording layer and the step of depositing the Ce containing layer.

36. A method for manufacturing an optical information recording medium according to claim 35, further comprising,
depositing an interface layer between the step of depositing the recording layer and the step of depositing the reflective layer.

37. A method for manufacturing an optical information recording medium according to claim 33, wherein Ar gas or a mixed gas of Ar gas and O₂ gas is used in the step of depositing the Ce containing layer.
